(19) United States
(12) Patent Application Publication
(10) Pub. No.: US 2013/0202025 A1
(43) Pub. Date: Aug. 8, 2013

(54) METHOD AND SYSTEM FOR TRANSMITTING VIDEO FRAME DATA TO REDUCE SLICE ERROR RATE

(71) Applicant: CANON KABUSHUKI KAISHA, Tokyo (JP)

(72) Inventors: Stéphane BARON, LE RHEU (FR); ROMAIN GUIGNARD, RENNES (FR)

(73) Assignee: CANON KABUSHIKI KAISHA, Tokyo (JP)

(21) Appl. No.: 13/756,199

(22) Filed: Jan. 31, 2013

(30) Foreign Application Priority Data
Feb. 2, 2012 (GB) 1201799.2

(51) Int. Cl. H04N 7/26

(52) U.S. Cl. CPC H04N 19/00139
USPC 375/240.02

(57) ABSTRACT

The present invention relates in general to video communication and streaming, and in particular, to transmitting video frame data over a communication network. A method of transmitting video frame data over a communication network comprises: obtaining a group of slices of a current video frame; assigning each of the slices to a channel of a plurality of channels reserved in a communication network; encoding each slice, based on channel characteristics of the channel to which it has been assigned, to obtain encoded data; packetizing the encoded data into encoded packets; and transmitting, over each of the reserved channels assigned to, the encoded packets comprising only encoded data of the corresponding assigned slice. This transmitting method reduces the slice error rate when transmitting several slices of a video frame over a communication network.

This application claims priority from GB patent application number 1201799 of Feb. 2, 2012, which is incorporated by reference herein in its entirety.

### FIELD OF THE INVENTION

The present invention relates in general to video communication and streaming, and in particular, to transmitting video frame data over a communication network.

### BACKGROUND OF THE INVENTION

For long time, video processing has meant drastically increasing the compression ratio to meet with available bandwidths of the communication network. Inter-frame spatial prediction is one of the most efficient encoding tools to obtain a satisfactory compression ratio.

The H.264 codec implements such an encoding tool but also other powerful tools that make it possible to keep a good quality level in rendering the video while providing high compression.

Communication techniques also help communicating devices to keep that quality level through various mechanisms. They include retransmission mechanisms that make it possible to send a data packet again when no acknowledgment of its first transmission has been received, and error concealment mechanisms that make it possible to correct some errors introduced in the data during its transmission (integrity error or loss of bits).

However, H.264-based codecs have drawbacks extremely detrimental to use on light portable devices, such as mobile phones or cameras.

Firstly, H.264 and the like make heavy demands on CPUs, such that the battery-limited and CPU-limited light portable devices cannot handle the encoding of large videos.

Secondly and more importantly, the inter-frame spatial prediction requires large high-speed access memory to store several consecutive frames based on which the spatial prediction of a following frame has to be carried out. The size of that required memory may even become colossal when processing high definition videos.

To overcome these drawbacks, a new generation of codecs is arising which no longer seeks to compress even more the video frames at any cost, but seeks to comply with low resource devices.

Such new codecs may be based on intra-frame spatial prediction only, more particularly on intra-slice prediction, to make it possible to store in memory only a reduced part of each frame when it is processed. As is well known, a slice defines, within a video frame, a coding unit made of a group or set of macro-blocks of pixels (below referred to as “macro-blocks”). However, other coding units (objects, pixel macro-blocks, etc.) and corresponding intra-coding-unit prediction may be used.

In conventional low resource devices embedding such codecs, a group of slices of a current video frame is first obtained; these slices are encoded using intra-prediction to obtain encoded slice data; the encoded slice data are packetized into encoded packets which are, in turn, transmitted over the communication network.

In parallel, communication techniques have been developed that increase the transmission throughput of data over the network.

This is for example the case with the simultaneous use of several physical channels, such as MIMO (standing for Multiple In Multiple Out) for several radio channels, to provide an increased throughput by aggregating the channel capacities. In that case, the encoded packets may be grouped into groups, and each group of encoded packets is then transmitted over a respective physical channel of the communication network, to compensate for the compression rate decrease due to using only intra prediction.

This is also the case with the wireless communication 802.11n protocol that provides, compared to basis 802.11 protocols, for aggregating the encoded packets into encoded data frames, where each encoded packet is generally inserted into a MAC Service Data Unit or MSDU, and the encoded data frames are known as Aggregated MSDUs or A-MSDUs.

Due to the properties of the A-MSDU (in particular the fact that only one addressee and one sending address can be specified), each A-MSDU can be transmitted alone as a MAC Protocol Data Unit or MPDU over the communication network, thus forming a virtual channel of transmission over that network. A single physical channel or several ones (e.g. using MIMO) may be used to convey these MPDUs.

The 802.11n protocol also provides for aggregating several encoded data frames A-MSDUs into aggregated data frames, known as A-MPDUs (standing for Aggregated-MPDU), thus offering several virtual channels within each A-MPDU. The aggregated data frames A-MPDUs are then transmitted over the communication network through a single physical channel or several ones (e.g. using MIMO).

Aggregating the encoded packets MSDUs and/or the encoded data frames A-MSDUs averages the cost of frame headers over a greater number of data. The average overhead for each encoded packet or data frame is thus reduced, and the total throughput is increased.

In video transmission, in particular video streaming or video live streaming, the low resource codecs are used in low latency schemes, which prevent from using the retransmission and error concealment mechanisms (or may use them at a very low level, for example with low error concealment).

Not using retransmission avoids adding latency, while not using error concealment decreases the memory used to store data on which the concealment is based.

Failing to use these mechanisms degrades the rendering quality of a transmitted video. This is because a non-retransmitted lost packet generally generates a loss of data in the video frame and thus a visual artefact on the video rendering. Similarly, non-concealed errors also produce visual artefacts on the video rendering.

However, using the above-introduced aggregating mechanisms (aggregation of channel capacities or of encoded packets/data frames) aggravates this decrease in video rendering quality.

In particular, the encoded data of the same initial slice or coding unit may finally be transmitted through several physical channels or through several A-MSDUs. In that case, the probability of loss of that slice or “slice error rate” (i.e. when error concealment mechanisms provided with the physical channel or the A-MSDU are not enough to correct the transmission errors or losses) significantly increases. This is because any error in one of the physical channels or A-MSDUs used will result in losing the corresponding part of the slice and thus the entire slice (because of the intra-slice prediction).

The aggravation of the rendering quality decrease is also because encoded data of several and generally consecutive slices may be transmitted over the same physical channel or A-MSDU. In that case, a loss occurring in the physical channel or A-MSDU used would affect simultaneously several slices, and generally consecutive slices, thus degrading the rendering more strongly. Indeed, a large visual artefact affecting several consecutive and neighbouring slices is generally more unpleasant than two visual artefacts affecting two slices that are far apart.

Therefore, there is a need to provide mechanisms for low latency and low memory codecs that improve the video rendering quality, in particular by controlling the splitting of the encoded data over different transmission channels.

Publication U.S. Pat. No. 7,885,337 B2 discloses a video slicing technique that places a resynchronization marker RM close to the beginning of each logical transmission unit. The resynchronization marker defines the beginning of a new slice and is inserted after the encoded macro-block of the current slice that just makes the encoded data overflow into the next logical transmission unit. In addition, this overflow triggers the end of the current slice.

The disclosed technique adapts the sizes of the slices to the sizes of the logical transmission units. Consequently, the number of slices within a current video frame cannot be known in advance and the number of encoded macro-blocks per elementary time period (i.e. logical transmission unit) may vary.

This appears not to be suitable for low latency and low memory codecs because the latter generally produce and consume the macro-blocks or the slices at a fixed cadence for streaming or live streaming.

The present invention has been devised to address at least one of the foregoing concerns, in particular to provide a controlled distribution of the video slices over the different transmission channels (physical channels or virtual channels A-MSDUs or the like) to face the above-indicated drawbacks of the aggregating mechanisms about slice error rate increase.

### SUMMARY OF THE INVENTION

In this context, according to a first aspect of the invention, there is provided a method of transmitting video frame data over a communication network, the method comprising:

obtaining a group of coding units of a current video frame;

assigning each of the coding units to a channel of a plurality of channels reserved in a communication network;

encoding each coding unit, based on channel characteristics of the channel to which it has been assigned, to obtain encoded data;

packetizing the encoded data into encoded packets; and

transmitting, over each of the reserved channels assigned to, the encoded packets comprising only encoded data of the corresponding assigned coding unit or units.

The present invention reduces the coding unit error rate, such as slice error rate, when transmitting several coding units of a video frame over a communication network. In particular, the coding units may be slices of macro-blocks of pixels. For ease of explanation, below the coding units will mainly be slices. Of course, coding units may cover any kind of pixel group such as objects, macro-blocks, etc.

The reduction of the coding unit error rate is achieved by assigning the coding units or slices to corresponding channels, thus defining slice-based substreams; and then by performing transmission of each substream over its assigned-to channel. This ensures the encoded coding units or slices are not split over several transmission channels while limiting the mixing of several coding units or slices over the same transmission channel.

In addition, the intra encoding is based on characteristics of the channels over which each substream will be sent, thus optimizing the use of reserved bandwidth.

According to a second aspect of the invention, there is provided a transmitting device for transmitting video frame data over a communication network, the device comprising:

an input module for obtaining a group of coding units of a current video frame;

an assigning module for assigning each of the coding units to a channel of a plurality of channels reserved in a communication network;

an encoder for encoding each coding unit, based on channel characteristics of the channel to which it has been assigned, to obtain encoded data;

a packetizer for packetizing the encoded data into encoded packets; and

a communication module for transmitting, over each of the reserved channels assigned to, the encoded packets comprising only encoded data of the corresponding assigned coding unit or units.

Other features of embodiments of the invention are further defined in the dependent appended claims.

For example, the group of coding units comprises the next slices of the current video frame that have to be transmitted at the next access to the communication network. This optimizes the reduction of slice error rate. This is because a risk only exists for the slices that are sent at the same network access (conflicting slices). The above provision may thus enable optimal distribution of the conflicting slices over all the available reserved channels.

In particular, the number of channels within said plurality of channels depends on the ratio Msi/Ts, where Msi is a maximum time between two successive accesses to the communication network and Ts is an average slice encoding time to encode one slice. The Msi value may for example be obtained from the Maximum Service Interval value specified in a TSPEC reservation request from the encoding application. This ratio defines an average number of slices that can be encoded between the two accesses, i.e. the number of slices in the above-defined group of slices. Consequently, the number of reserved channels can be defined directly from the average number of slices to be transmitted at the next access to the communication network.

According to a particular feature, the number of channels is equal to the ratio ┌Msi/Ts┐, where ┌.┐ is the ceiling function. This may be implemented when packetizing the encoded data provides encoded packets aligned with the slices, i.e. which does not span between slices. This is because in that case all the packets only comprise encoded data belonging to the same slice-based substream (i.e. aligned with the slices).

Conversely, when packetizing the encoded data provides encoded packets not aligned with the slices, the plurality of channels may comprise a slice-independent reserved channel over which the encoded packets comprising encoded data of slices assigned to two different channels are transmitted. In that case, the number of channels may be equal to ┌Msi/Ts┐+1, where ┌.┐ is the ceiling function. Attention will be given to that particular slice-independent channel so that no aggregation of encoded packets is performed therein. This is to avoid affecting a large number of slices due to loss of a resulting aggregated frame.

According to a particular feature of the invention, assigning the coding units assigns non consecutive coding units of the group of coding units to the same channel. This may be done by assigning only one slice to each channel as suggested above when the number of channels is Msi/Ts. This improves the video rendering quality since in that case a loss of data within a channel will not affect neighbouring slices or coding units in a displayed frame.

In one embodiment of the invention, the method further comprises aggregating the encoded packets into encoded data frames, wherein aggregating is a channel-oriented aggregating operation that aggregates, into the same data frame, only encoded data of the coding unit or units assigned to the same channel. This avoids building encoded packets comprising encoded data of slices assigned to two different channels. This provision increases the throughput of the corresponding channel thanks to the aggregation mechanism while optimizing the low slice error rate according to the invention thanks to using each channel only for conveying data of the same coding unit or units (e.g. slices).

This may be used for example in the case of wireless communications according to the 802.11 protocol. In that case, the encoded packets are framed into MAC Service Data Units, MSDUs, and the data frame comprises an aggregated-MAC Service Data Unit, A-MSDU, also corresponding to a MAC-Protocol Data Unit that aggregates MSDUs. In this situation, the reserved channels of said plurality are MAC Protocol Data Unit, MPDU, slots within an aggregated-MAC Protocol Data Unit, A-MPDU, of the 802.11 protocol, wherein each MPDU includes an aggregated-MAC Service Data Unit, A-MSDU. The A-MPDUs can be transmitted over the network using one or several physical channels. These various provisions optimize the use of the A-MSDUs of the 802.11 protocol, because each of them has only one light error concealment mechanism that causes the whole A-MSDU to be discarded in case of non concealable error.

In a variant, the reserved channels of said plurality are physical channels in the communication network. When implementing this case in the 802.11 protocol, the encoded packets are framed into MAC Service Data Units, MSDUs, and are transmitted over the communication network using a wireless Multi In-Multi Out communication technology.

According to one embodiment of the invention, assigning the coding units to channels of said plurality depends on characteristics of encoded data resulting from the encoding of corresponding coding units in a previous video frame and on characteristics of said reserved channels. For example, this makes it possible to assign coding units or slices assumed to be complex for which the encoding is assumed to generate a large amount of data (large throughput) at fixed video rendering quality to the channels with large bandwidth. It results in optimizing the use of the available channels.

Complexity of the coding units or slices is based on what happened when encoding the previous video frame, since most of the time the changes between allocated positions of two successive frames are slight.

For the purpose of illustration, slices of the previous video frame that correspond to the slices to assign may for example be collocated slices, i.e. slices having the same slice index between the current and previous video frames or slices that have the closest spatial position within their respective video frames. This may be the same for any other kind of coding unit.

In a particular embodiment of this assigning, the coding units are ordered or “ranked” in a coding unit list according to an encoded quality value or an encoded output bit rate value of the encoded data resulting from the encoding of their corresponding coding units in the previous video frame; the channels of said plurality are ranked in a channel list according to their respective reserved channel bandwidths; and the assigning of the coding units to channels follows the ranks of the ranked coding unit list and of the ranked channel list. As suggested above, slices ranked according to their output bit rate are respectively assigned to channels ranked according to their available bandwidth.

According to another embodiment of the invention, the method further comprises modifying the size of coding units, in particular slices, before encoding them. The size of a coding unit may correspond for example to the number of macro-blocks it comprises or to the bitstream size of the corresponding encoded data. Thanks to this provision, the encoding of the slices can be dynamically adapted to the available bandwidth of the associated reserved channel.

In particular, modifying the size of a coding unit in the current video frame depends on an encoded quality value of the encoded data resulting from the encoding of a corresponding coding unit in a previous video frame. According to this provision, the modification is performed based on what happened when encoding the previous video frame. This is because it may be inferred from the previous encoding whether the available bandwidth is undersized or oversized given a previously encoded coding unit or slice that is considered to be very close in coding complexity to the current coding unit or slice. The above provision thus adjusts the slice size to better use the bandwidth.

According to a particular feature, modifying the size of a coding unit of said group comprises:

determining whether the encoded quality value resulting from the encoding of the corresponding coding unit in the previous video frame is higher or lower than an average encoded quality value resulting from the encoding of a corresponding group of coding units in the previous video frame. Where the coding units are slices, the corresponding group of slices may for example be the group of slices having the same GOS index in the previous video frame; and

reducing the size of the coding unit by a given number of macro-blocks of pixels if it is determined that the encoded quality value is lower than the average encoded quality value; or increasing the size of the coding unit by the given number of macro-blocks of pixels if it is determined that the encoded quality value is higher than the average encoded quality value.

Implementing this provision makes it possible to progressively modify the sizes of the slices as successive video frames are processed, to finally average the encoded quality value (for example PSNR—Peak signal-to-noise ratio) over any considered group of slices, i.e. possibly for each new access to the communication network.

According to another particular feature, when the size of a coding unit is modified, the next coding unit in the current video frame is inversely modified, to ensure the same number of coding units is kept within the current video frame. Modifying the slice sizes in such a way that the total number of slices in the video frame is maintained makes it possible to use very simple synchronization mechanisms between the transmitter and the receiver. This is because by processing a fixed number of slices at each network access, a fixed number of network accesses is needed to process each new entire video frame. Synchronization at each video frame is thus maintained without additional means.

According to yet another embodiment of the invention, the method further comprises obtaining stream characteristics of a video stream made of video frames; determining a number Ns of channels based on at least one obtained stream characteristic; generating and sending over the communication network Ns channel reservation requests based on the obtained stream characteristics and the number Ns, to reserve said plurality of channels. This makes it possible to define channel characteristics for each channel (for example a target bit rate or a maximum bitstream size), based on which the encoding can be performed.

According to yet another embodiment of the invention, encoding each coding unit uses intra prediction within the respective coding unit. In particular, the channel characteristics based on which each coding unit is encoded comprises reserved bandwidth (or bitrate).

According to yet another embodiment of the invention, the method may further comprise:

obtaining encoding statistics from the encoded data of first coding units;

creating a plurality of classes as a function of at least one item of characteristic information of the obtained statistics;

reserving a plurality of transmission channels for the respective plurality of classes, each channel having a reserved bandwidth that depends on a value of the characteristic information for the respective class;

assigning second coding units each to one of the classes; and

transmitting the encoded data of each second coding unit over the reserved channel corresponding to the class to which said each second coding unit is assigned;

wherein the encoding of the second coding units depends on the reserved bandwidths of their respective transmission channels.

This provision improves the use of the network bandwidth in case of multi-channel transmission of compressed video data.

The corresponding transmitting device may thus comprise:

a statistics-gathering module for obtaining encoding statistics from the encoded data of first coding units;

a class building module for creating a plurality of classes as a function of at least one item of characteristic information of the obtained statistics; and

a channel reservation module for reserving a plurality of transmission channels for the respective plurality of classes, each channel having a reserved bandwidth that depends on a value of the characteristic information for the respective class,

wherein the assigning module assigns second coding units each to one of the classes;

the communication module transmits the encoded data of each second coding unit over the reserved channel corresponding to the class to which the second coding unit is assigned; and

the encoding of the second coding units depends on the reserved bandwidths of their respective transmission channels.

In particular, the encoding statistics comprises parameters defining a modeling normal (or Gaussian) distribution that models said number of coding units as a function of the bitstream size or bitrate of the corresponding encoded data. In particular, the parameters include the mean and the variance of said modeling normal distribution.

These provisions allow the building of precise statistics at very low costs, in particular to store only the two above-defined parameters.

According to a particular feature, the method comprises resetting the encoding statistics to start a new analysis time period and gathering encoding statistics from the coding units encoded during that new analysis time period before triggering an update of transmission channel bandwidth allocation that comprises said creating, reserving and assigning based on said gathered encoding statistics.

This defines analysis time periods to determine whether or not the bandwidth allocation has to be revised. For example, a new analysis time period may be triggered on detecting a change of sequence in the video frames. In another example, the new analysis time period may start directly at the end of the previous analysis time period.

In particular, the update of the transmission channel bandwidth allocation is triggered at the end of an analysis time period if parameters of the encoding statistics gathered during that analysis time period exceed at least one threshold value. Thanks to this provision, an update of the bandwidth allocation is conducted only in case of substantial statistical deviation, i.e. mirroring substantial changes in the video frames.

According to another particular feature, creating a plurality of classes comprises splitting the obtained statistics into a respective plurality of subparts based on the characteristic information (mean and variance of a normal distribution modeling the encoding statistics). For example, the total range of a normal distribution may be approximated to the interval [−3σ,+3σ] where σ² is the variance. This makes it possible to homogeneously distribute or assign the coding units (e.g. slices) to the several classes (and thus to the several transmission channels).

In particular, the characteristic information comprises a bitstream size or bitrate of encoded data, and the reserved bandwidth of a transmission channel is based on the maximum bitstream size or bitrate of the subpart defining the respective class. By choosing the maximum bitstream size or bitrate, the transmission channels are designed with enough bandwidth to statistically convey the encoded data of their assigned coding units.

Another aspect of the invention relates to a non-transitory computer-readable medium storing a program which, when executed by a microprocessor or computer system in an apparatus transmitting video frame data over a communication network, causes the apparatus to perform the steps of:

obtain a group of coding units of a current video frame;

assign each of the coding units to a channel of a plurality of channels reserved in a communication network;

encode each coding unit based on channel characteristics of the channel to which it has been assigned, to obtain encoded data;

packetize the encoded data into encoded packets; and

transmit, over each of the reserved channels assigned to, the encoded packets comprising only encoded data of the corresponding assigned coding unit or units.

The non-transitory computer-readable medium may have features and advantages that are analogous to those set out above and below in relation to the methods of transmitting video frame data, in particular that of reducing the slice error rate.

Another aspect of the invention relates to a method of transmitting video frame data substantially as herein described with reference to, and as shown in, FIG. 8; FIGS. 7 and 8 of the accompanying drawings.

At least parts of the method according to the invention may be computer implemented. Accordingly, the present invention may take the form of an entirely hardware embodiment, an entirely software embodiment (including firmware, resident software, micro-code, etc.) or an embodiment combining software and hardware aspects which may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium, for example a tangible carrier medium or a transient carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical video streaming system;

FIG. 2 is a block diagram illustrating components of a communicating device in which embodiments of the invention may be implemented;

FIG. 2a illustrates other function blocks of the same communicating device;

FIG. 3 illustrates the aggregation mechanisms of the conventional 802.11n protocol;

FIG. 4 illustrates frame slicing and a segmentation of a slice into several MSDUs according to the conventional 802.11n protocol;

FIG. 5 illustrates a misalignment issue in case of 802.11n aggregation;

FIG. 6 is a flowchart illustrating general steps of a process for reserving bandwidth in a prior art 802.11e protocol and QoS network and for streaming video data;

FIG. 7 is a flowchart illustrating steps of a channel reservation process according to embodiments of the invention;

FIG. 8 is a flowchart illustrating steps of encoding and transmission processes according to embodiments of the invention, in particular following the channel reservation of FIG. 7;

FIG. 9 illustrates the slicing adaptation according to embodiments of the inventions;

FIG. 10 is a flowchart illustrating steps of a streaming process of video data itself according to embodiments of the invention;

FIG. 11 illustrates a dynamic reallocation of bandwidth for the plurality of transmission channels according to embodiments of the invention; and

FIG. 12 illustrates the bandwidth dynamic adaptation in case of several successive sequences in a video stream.

### DETAILED DESCRIPTION OF EMBODIMENTS OF THE INVENTION

The invention provides methods and devices of transmitting video frame data over a communication network. This may be for example a wireless communication network according to the 802.11n protocol, i.e. in which an aggregation of data is allowed at the Medium Access Control, MAC, layer.

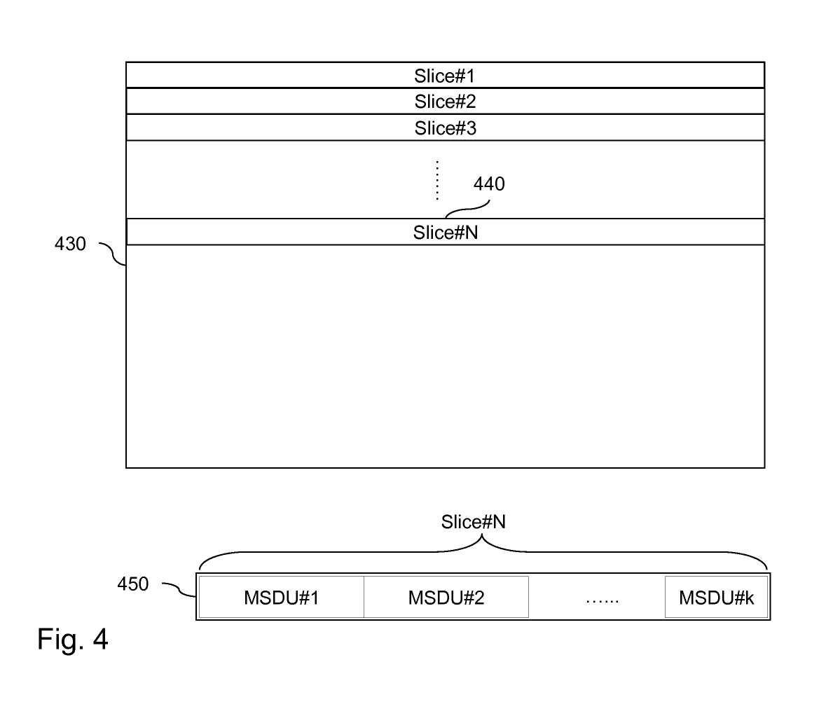

As is well known, a video frame is divided into coding units such as slices, where the slices are made of macro-blocks of pixels, e.g. 16 pixels×16 pixels macro-blocks. The top of FIG. 4 for example illustrates a line-based codec that divides the video frame 430 into line-based slices 440, for example 16-line slices (i.e. each line of 1 macro-block height). While the invention may apply to various kinds of coding units, reference is made below to slices, which are well known, to illustrate embodiments of the invention.

As illustrated below, the invention may come within the scope of live video streaming in wireless communication systems.

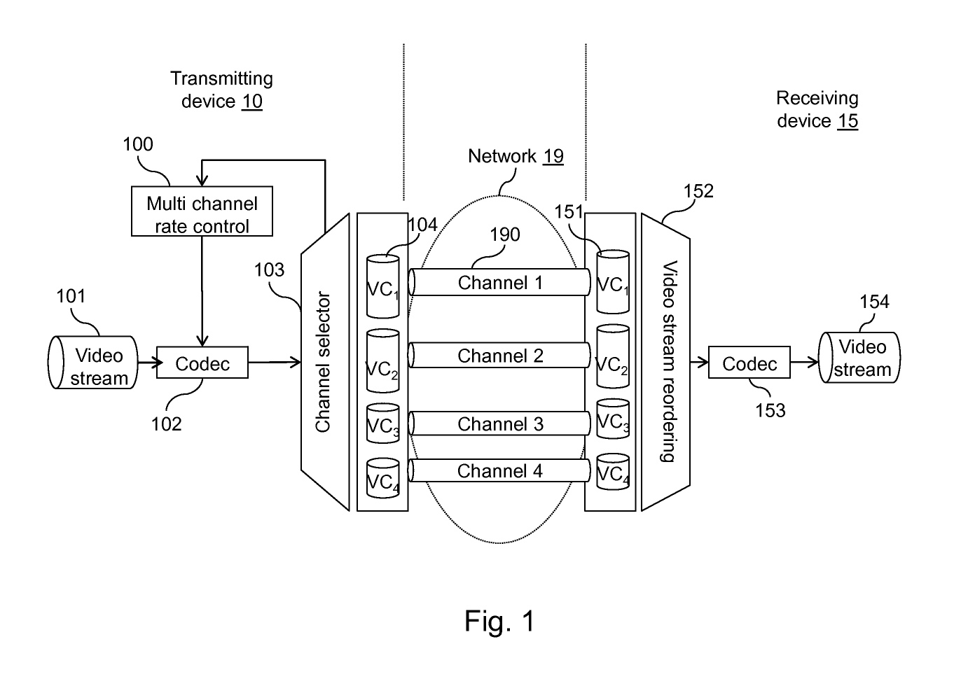

A typical video streaming system is shown in FIG. 1.

It comprises a transmitting device 10 and a receiving device 15, interconnected through the communication network 19. The devices are preferably low latency and low memory devices as introduced above.

As shown, the communication network 19 can support a plurality of physical or virtual transmission channels 190. Several physical transmission channels may result from implementing the wireless MIMO technology. Several virtual transmission channels may result from implementing A-MPDUs as defined in the 802.11n protocol, where each MPDU slot in the A-MPDUs can be seen as a virtual channel. This is because all the data within an MPDU have the same transmitting address and the same addressee. According to various combinations, a virtual channel can transmit data using one or several physical channels while a given physical channel can be used by one or several virtual channels.

The transmitting device 10 receives a raw video stream 101 to be encoded, for example via an HDMI interface. The video stream is encoded by an intra-prediction codec 102 to be streamed over the communication network, i.e. its video frames and their slices are encoded using spatial intra prediction. In particular the slice-based intra prediction means that each slice is encoded without any link with a previous slice or frame. This drastically reduces the memory needed to perform the prediction since only the current slice has to be stored temporarily (for example only a 1-macro-block-height line as shown in FIG. 4). In particular “off line” embodiments, the raw video stream 101 may be first encoded using high compression rate codecs before it is stored locally. High compression rate codecs may implement both inter and intra predictions to generate highly compressed data. This data may then be used for video streaming in which case the encoding is modified so that only the intra prediction remains (e.g. by transcoding or by removing the inter prediction).

The resulting bit stream provided by the encoding application is then sent to the MAC layer where a channel selector 103 selects the channels 190 over which packets of the encoded slice data are to be transmitted to the remote device 15. The channel selector 103 stores the encoded packets in buffers 104 corresponding to each of the channels 190.

At the receiving device 15, received packets of the video bit stream are stored in receiving buffers 151 corresponding to each of the channels. They are processed by the MAC layer where a video stream reordering module 152 reorders the received data to ensure that a complete standalone-encoded entity, i.e. a slice, is received before transmitting it to an application of an upper layer, here to a video decoder 153.

The video decoder 153 decodes the received and reordered bit stream into a raw video element 154 which is thereafter displayed on a display.

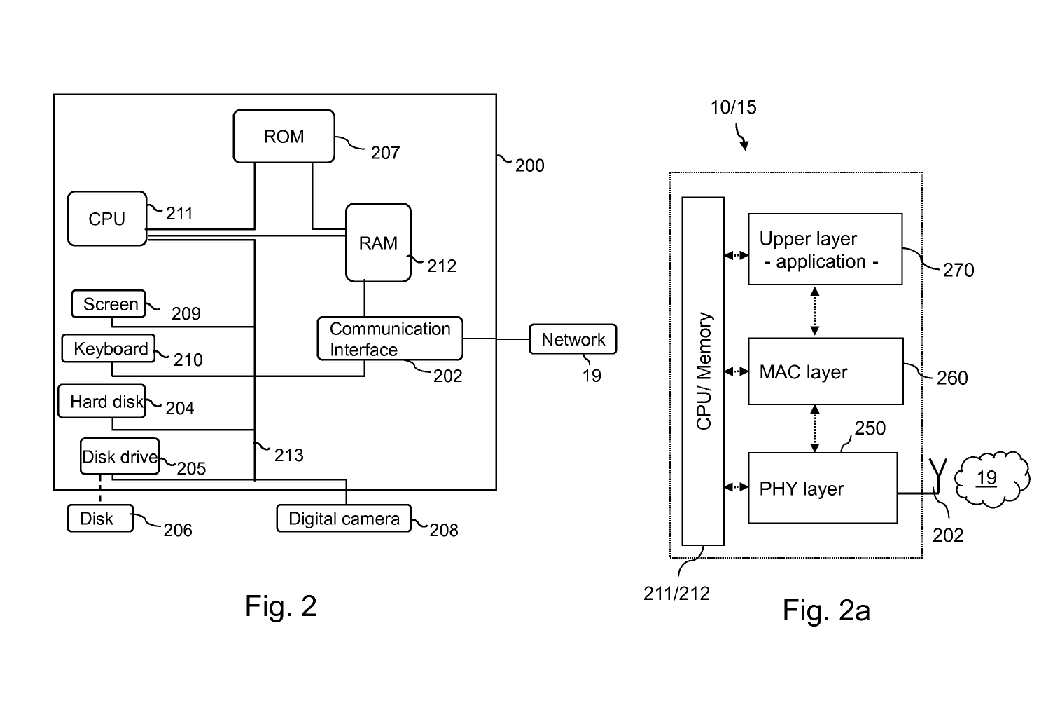

FIG. 2 schematically illustrates a communicating device 200, either the transmitting device 10 or the receiving device 15, or a device embedding both functionalities, configured to implement at least one embodiment of the present invention. The communicating device 200 may be a device such as a micro-computer, a workstation or a light portable device. The communicating device 200 comprises a communication bus 213 to which there are preferably connected:
a central processing unit 211, such as a microprocessor, denoted CPU;
a read only memory 207, denoted ROM, for storing computer programs for implementing the invention;
a random access memory 212, denoted RAM, for storing the executable code of the method of embodiments of the invention as well as the registers adapted to record variables and parameters necessary for implementing methods according to embodiments of the invention; and
a communication interface 202 connected to the communication network 19 over which digital data packets or frames are transmitted, for example a wireless communication network according to the 802.11n protocol. The communication interface 202 may comprise one or several network interfaces, for instance wired and wireless interfaces or different kind of wired or wireless interfaces. Several network interfaces are for example used when a MIMO communication interface is implemented (several radio antennas). The data are written to the network interface for transmission or read from the network interface for reception under the control of a software application running in the CPU 211.

Optionally, the communicating device 200 may also include the following components:
a data storage means 204 such as a hard disk, for storing computer programs for implementing methods of one or more embodiments of the invention and raw video data used or produced during the implementation of one or more embodiments of the invention;
a disk drive 205 for a disk 206, the disk drive being adapted to read raw video data from the disk 206 or to write encoded data onto said disk;
a screen 209 for displaying decoded data and/or serving as a graphical interface with the user, by means of a keyboard 210 or any other pointing means.

The communicating device 200 can be connected to various peripherals, such as for example a digital camera 208, each being connected to an input/output card (not shown) so as to supply raw video data to the communicating device 200.

The communication bus provides communication and interoperability between the various elements included in the communicating device 200 or connected to it. The representation of the bus is not limiting and in particular the central processing unit is operable to communicate instructions to any element of the communicating device 200 directly or by means of another element of the communicating device 200.

The disk 206 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables a method according to the invention to be implemented.

The executable code may be stored either in read only memory 207, on the hard disk 204 or on a removable digital medium such as for example a disk 206 as described previously. According to a variant, the executable code of the programs can be received by means of the communication network 19, via the interface 202, in order to be stored in one of the storage means of the communicating device 200, such as the hard disk 204, before being executed.

The central processing unit 211 is adapted to control and direct the execution of the instructions or portions of software code of the program or programs according to the invention, which instructions are stored in one of the aforementioned storage means. On powering up, the program or programs that are stored in a non-volatile memory, for example on the hard disk 204 or in the read only memory 207, are transferred into the random access memory 212, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

FIG. 2a illustrates, through functional blocks, the same communicating device. It comprises a physical (PHY) layer 250, a Medium Access Control (MAC) layer 260 and an upper layer 270 that includes for example the encoding or decoding application.

The MAC layer 260 is a multi stream capable Medium Access Control layer, meaning that it is adapted to discriminate various input streams to avoid aggregation or grouping of data from different streams into the same aggregated unit or group. This is based on the property that a communicating device according to the invention can efficiently provide a low slice error rate by avoiding transmitting encoded data of different slices over the same virtual or physical channel 190. This discriminatory ability is based on a channel identifier TSID (standing for Transport Stream Identifier) that is given to each item of data by the upper application layer 270, the MAC layer being able to aggregate only data having the same TSID.

The PHY layer 250 is of a well-known type, and is connected to the network interface, for example a radio antenna or MIMO radio antennas.

At the transmitting device 10, a group of slices of a current video frame in a raw video stream is obtained; each of the slices of that group is assigned to a channel of a plurality of channels 190 reserved in the communication network 19; and each slices is encoded by the encoding application of the upper layer 270 using intra-prediction, based on channel characteristics of the channel to which it has been assigned, to obtain encoded slice data. These encoded slice data are packetized into encoded packets by a Protocol Adaptation Layer (PAL), not shown in the upper layer 270. Packetizing generally means that the encoded slice data are concatenated as they are produced (i.e. scanning order of the video frame) and segmented into packet-sized groups.

The encoded packets are then transmitted to the MAC layer 260 where they are transmitted, via the PHY layer and over each of the reserved channels assigned to, the encoded packets comprising only encoded slice data of the corresponding assigned slice or slices. This slice-oriented transmission over each channel that provides the above mentioned low slice error rate is also based on the fact that an assigning of the slices to the channels has been done previously.

A controlled splitting of the encoded data is thus performed between the several channels available to communicate with the receiving device.

Also embodiments of the invention provide a dynamic adaptation of the reserved bandwidth of the transmission channels so as to follow the real need of the video stream being encoded. This is because its content complexity varies from frame to frame, thus making first reserved bandwidths no longer adapted to the amount of encoded slice data as the frames are processed.

In this situation, at the transmitting device 10, coding units such as slices of a video frame in a raw video stream are encoded into encoded slice data by the encoding application of the upper layer 270; encoding statistics from the encoded slice data of first slices are gathered; a plurality of classes is created as a function of at least one item of characteristic information of the obtained statistics, for example a function of the bitstream size of the encoded slice data for each slice or each composing macro-block; a plurality of transmission channels 190 is thus reserved for the respective plurality of classes, each channel having a reserved bandwidth that depends on a value of the characteristic information for the respective class; each of the second slices is then assigned to one of the classes; and the encoded slice data of each second slice is transmitted over the reserved channel 190 corresponding to the class to which the second coding unit is assigned. To ensure appropriate use of the reserved bandwidths, it is furthermore provided that the encoding of the second slices is made after having reserved the bandwidths over which they will be transmitted, meaning that the encoding of the second slices depends on the reserved bandwidths of their respective transmission channels.

At the receiving device 15, no particular adaptation is needed and conventional receiving devices may be used. This is because embodiments of the invention only control the way the encoded slice data are spread over the several channels but this does not modify how the receiving device reorder the received data.

As briefly introduced above, embodiments divide the video streams into slice-based sub-streams corresponding to the reserved channels and constrains the coder to encode each slice-based sub-stream with characteristics of the corresponding channel, for example a maximum or target bit rate, that may be in some embodiments dynamically adapted as explained below. The resulting encoded data of the same slice may then entirely be transmitted over the same transmission channel thanks to the MAC layer property of managing the sub-streams independently.

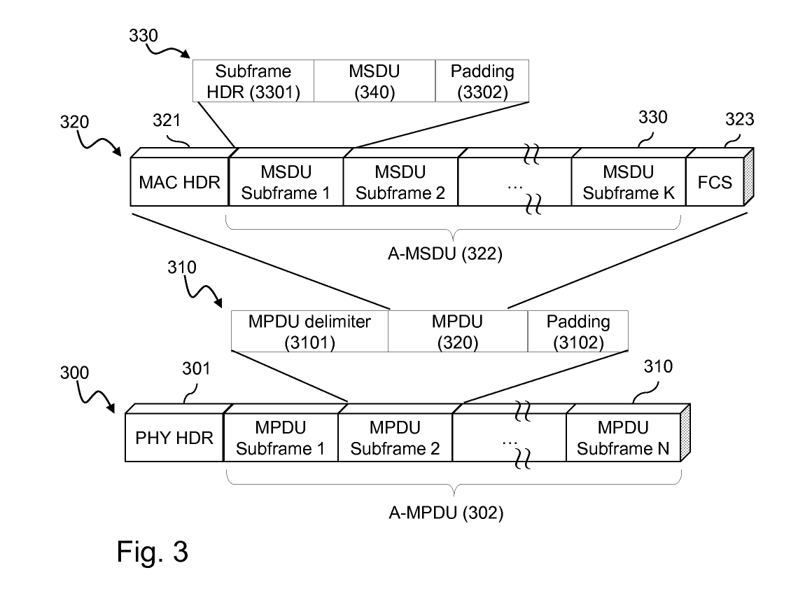

A 802.11n protocol-based embodiment is now described with more detail in reference to FIGS. 3 to 12. Among these Figures, FIGS. 3 to 6 provide details about state of the art issues that are used in this embodiment.

The IEEE 802.11n-2009 protocol standard is an amendment to the IEEE 802.11-2007 wireless networking standard to improve network throughput over the three preceding standards, namely 802.11a, 802.11b and 802.11g, with a significant increase in the maximum raw data rate from 54 Mega bits per second (Mbit/s) to 600 Mbit/s. In 802.11a/b/g, the data packets are framed into MAC Service Data Units (MSDUs), and each MSDU is framed into a MAC Protocol Data Unit (MPDU) with its own header and error concealment (Cyclic Redundancy Check—CRC—for example) information. Then each MPDU is sent over the network into an appropriate PHY data frame with proper headers. It is directly inferred that there is direct matching between a PHY data frame, a MPDU data frame and a MSDU data frame.

The amendments in the standard concentrate on improving the MAC protocol efficiency by using a single acknowledgement (ACK) mechanism for multiple data frames and by aggregating multiple data frames into a single transmission frame.

Regarding the ACK mechanism, in 802.11a/b/g, each PHY data frame is acknowledged immediately after its reception by the receiver meaning that no other PHY data frame can be transmitted over the network while the current transmitting device is waiting for the ACK of the transmitted PHY data frame.

In 802.11n, a block ACK (BA) mechanism is provided according to which multiple PHY data frames can be transmitted over the network and acknowledged by the receiving device using a single ACK frame. This obviously reduces the average waiting time between PHY data frame transmissions.

In practice, the transmitting device sends a BA request (BAR) to the receiving device, once the multiple PHY data frames have been sent. The BA response, i.e. the ACK frame, comprises a compressed bitmap mapped onto each one of the multiple PHY data frames and in which the status (failure/success) of receiving each data frame is written.

FIG. 3 illustrates the aggregation mechanisms by showing the data frame format resulting from the complete scheme of such aggregations. These aggregation mechanisms make it possible to send multiple data frames at each access to the medium of the wireless communication network. This is done by combining several of such data frames into one larger data frame then sent through a PHY data frame.

There are two levels of frame aggregation, where only one of them can be implemented or both simultaneously to increase the throughput.

The first level results in Aggregated-MAC Service Data Units (A-MSDUs) by aggregating several MSDUs together. This means that the encoded packets of encoded slice data are framed into MAC Service Data Units, MSDUs, and a data frame resulting from the aggregation comprises an aggregated-MAC Service Data Unit, A-MSDU.

The second level results into Aggregated-MAC Protocol Data Units (A-MSDUs) by aggregating several MPDUs together.

The above part of FIG. 3 illustrated the A-MSDU aggregation in which an MPDU data frame 320 (up to 8 Kbytes) combines smaller MSDU data frames 330 having the same physical source and destination end points and traffic class (i.e. Quality of Service—QoS) into a larger combined A-MSDU 322, with a common MAC header 321 and a Frame Check Sequence (FCS) field 323. In particular, the traffic class may indicate a four-bit Transport Stream Identifier (TSID) that is associated with each MSDU by the upper layer 270. A-MSDU thus aggregates MSDUs having the same TSID.

The A-MSDU 322 concatenates N unitary MSDU sub-frames 330, each containing a network packet MSDU 340 received from upper layer, a sub-frame header 3301 and a padding field 3302. Practically N can vary according to MSDU size.

The sub-frame header 3301 is 14-byte-long and encodes a 2-byte-long MSDU length field, a 6-byte-long MSDU source address field and a 6-byte-long MSDU destination address field. The MSDU length field indicates the length, in bytes, of MSDU 340.

The padding field 3302 is used to pad the sub-frame header 3301 together with MSDU 340 with 0 to 3 bytes to round sub-frame 330 onto a 32-bit word boundary.

The MAC header 321 is a conventional 802.11 MAC 30-byte header, comprising the destination address of the A-MSDU (practically the next immediate intended receiving device of the aggregated frame); the source address of the A-MSDU (practically the station that created the A-MSDU); other fields (Frame control, Duration/ID, Sequence Control, QoS control and HT Control) characterizing properties of the aggregated MSDUs in A-MSDU 322. For example, the QoS control contains one bit flag indicating the presence of an A-MSDU 322 in the body of the MAC frame. This makes it possible to specify whether or not the A-MSDU aggregation mechanism is enabled, when switching back for example to the conventional 802.11a/b/g protocol without aggregation mechanism.

The FCS field 323 is a conventional CRC-32 checksum used to check the integrity of MPDU 320. Since only one FCS field is used for the several aggregated MSDUs, it is not possible to determine which MSDU is affected by an un-concealable error. The whole MPDU is thus discarded while it possibly comprises encoded slice data from several slices according to prior art approaches. As explained above, this is very detrimental to the video rendering quality since several slices are lost.

The bottom part of FIG. 3 illustrated the A-MPDU aggregation in which a PHY data frame 300 (up to 64 Kbytes) combines several MPDU sub-frames 310 within an A-MPDU structure 302. The bottom part of the MAC layer produces the A-MPDU structure 302 while the PHY layer adds a conventional PHY header 301 to it to produce PHY data frame 300.

Each MPDU sub-frame 310 is made of one MPDU 320 as defined above (i.e. resulting from A-MSDU) or as defined in the 802.11a/b/g protocol (i.e. resulting from a single MSDU), a prefixing MPDU delimiter 3101 and possible padding field 3102 to pad the delimiter 3101 and MPDU 320 onto a 32-bit word boundary.

Conventionally, the MPDU delimiter 3101 embeds a proper CRC field and a length field, used by the receiving device to respectively check the MPDU integrity and parse the A-MPDU structure 302 into several MPDUs sub-frames 310.

Thanks to the MPDU-based CRC field, an error occurring in one of the MPDUs of the A-MPDU structure 302 does not affect the other MPDUs of the structure. Each MPDU, i.e. each slot in the A-MPDU structure, thus forms a virtual independent channel in a stream of successive A-MPDU structures 302 (embedded in corresponding PHY data frames 300). As briefly introduced above, these slots will be used as channels to which slices will be assigned according to this 802.11n-based embodiment.

When the aggregation mechanisms are implemented, the bitmap of the ACK mechanism may be enhanced to comprise bits mapped onto each MPDU in the A-MPDUs of several PHY data frames.

Returning to FIG. 4, it shown in its bottom part how a slice is fragmented to fit the MAC requirements in terms of maximum segment size. Numeral 450 references the encoded slice data resulting from the encoding of the slice #N 440.

The encoded slice data of slice 440 are fragmented into several MSDUs for which the 802.11 protocol defines a maximum size. Typically, MSDU maximum size is 2304 bytes.

That means that, when considering a video codec coding a High definition 1080p/60 fps (1080 pixels wide and 60 frames per second) video and producing a 400 Mbit/s encoded video stream using a 16-lines based slicing, around 5.6 MSDUs should be required on average to carry the encoded slice data of a single slice. This is because the average slice size is about 400/(60*(1080/16)) Mbit=12.6 Kbytes and thus the number of MSDUs is 12.6*1024/2304≈5.6. In this typical example, on average, a slice will be split into 5.6 MSDUs for a total of around 12.6 Kbytes in the bitstream.

As shown in the Figure, the last MSDU may not be entirely used with regard to the MSDU maximum size of 2304 bytes. This is because the amount of encoded slice data varies for each slice, for example depending on slice content complexity.

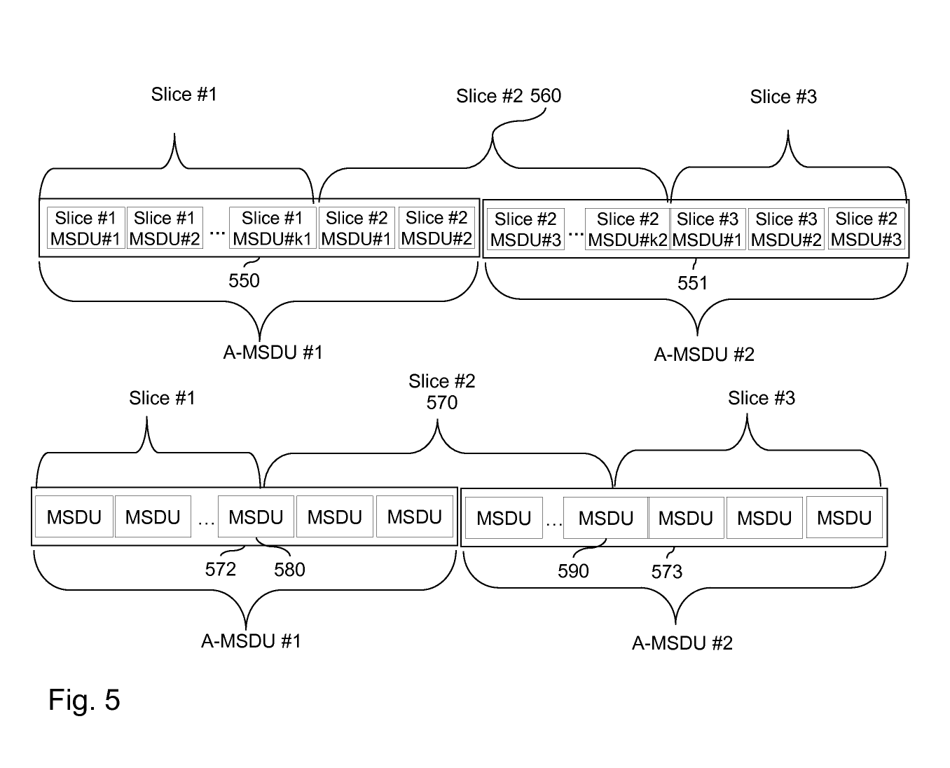

Ending an MSDU when the encoding of the corresponding slice ends is named slice-aligned MSDU and is shown in the top of FIG. 5 where each MSDU is dedicated to only one slice.

To enhance the throughput by using the remaining part of the last MSDU used to store the last encoded slice data of a first slice, the first encoded slice data of the next slice can be concatenated with said last encoded slice data in said last MSDU. This well-known approach is referred to as non-aligning the MSDUs onto the slices and is shown in the bottom part of FIG. 5 in which MSDUs 580 and 590 comprise encoded slice data of several slices, and are thus referred to “mixing MSDUs”.

FIG. 5 illustrates the content of A-MSDUs in the prior art systems, when encoding slices.

In case of MSDUs aligned with the slices (above part of the Figure), the encoded slice data of slice#2 560 are packetized (or fragmented) into k2 MSDUs, a first part of which being aggregated (or concatenated) in a first A-MSDU 550 and the remaining part of which being aggregated in a second A-MSDU 551. This example shows that the prior art systems do not implement A-MSDUs aligned with the slices.

This misalignment at the A-MSDU level has a main drawback as already introduced above: if one A-MSDU 550 or 551 is lost or affected by non-concealable errors, two slices will be corrupted and thus discarded together. This would result in strong visual artifacts, in particular if the two slices are consecutive slices (i.e. neighboring slices when displayed) which is often the case. Of course, any A-MSDU can convey parts of more than two slices, in which case the loss of that A-MSDU would produce even worse visual artifacts.

Incidentally, if the same slice is spread over a large number of A-MSDUs since the latter may mix encoded slice data of several slices, the error slice rate is significantly high compared to a hypothetically-optimized use of the A-MSDU arrangements.

The same applies in case of MSDUs non-aligned with the slices (bottom part of the Figure), for which a slice-based alignment at the A-MSDU level appears unrealistic since the last MSDUs of each slice, namely the mixing MSDUs 580 and 590, cannot permit an A-MSDU to end with the last encoded slice data of a given slice.

As set out above, embodiments of the invention provides a solution to this issue of increased error slice rate and degraded video rendering quality.

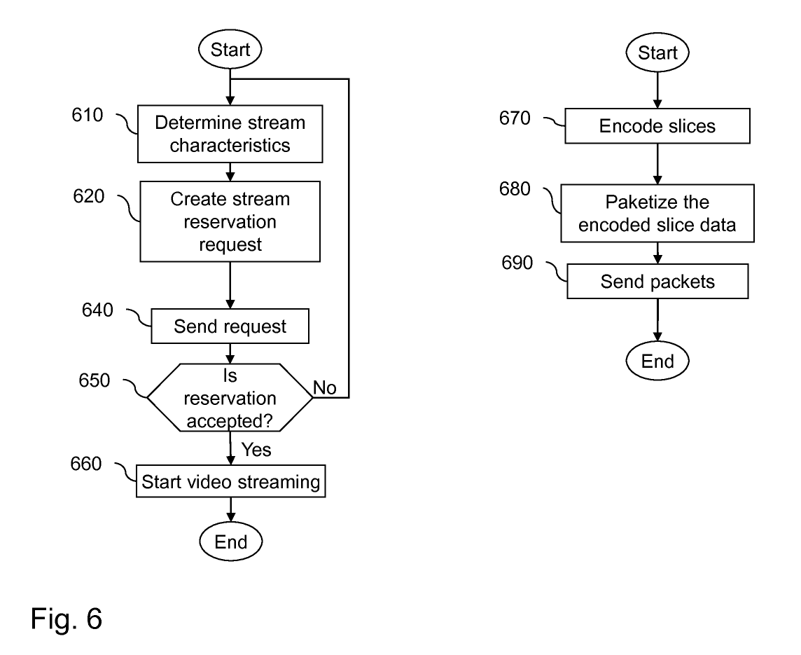

FIG. 6 illustrates, in a flowchart, general steps of a typical video streaming process according to the prior art in a QoS-aware video streaming system.

QoS-aware video streaming systems generally provide quality of service in streaming video using a preliminary reservation process during which a transmission channel with required quality features is reserved. For example, the video streamer (i.e. the transmitting device) may reserve a part of the bandwidth corresponding to its video stream needs.

An example of reservation mechanism is the Hybrid Coordination Function Controlled Channel Access, or HCCA, which is an option defined in the 802.11e protocol. It is to be noted that 802.11n is 802.11e compatible. The following description will mostly refer to HCCA for the purposes of illustration, since the invention may implement any kind of reservation mechanism that provides QoS.

The left part of FIG. 6 mainly regards the reservation process while the right part of it regards the streaming of video data itself.

The reservation process starts at step 610 by analyzing some characteristics of the encoded video stream, for example the minimum, average and maximum required bandwidths (i.e. produced min, average and max throughputs), a time bounds, etc. In a 802.11 network implementing the HCCA option, a TSPEC structure as defined in 802.11e is then created to store the obtained characteristics. This TSPEC structure thus defines a channel to be reserved over which the encoded video stream will be transmitted and a channel identifier TSID is assigned to the channel. One may also note that the required bandwidth is upper bounded by the transmission capacities, for example by the maximum size of the A-MPDUs multiplied by the number of A-MPDUs sent at each medium access and by the frequency of medium access.

At step 620, a reservation request frame is created. In a 802.11 network implementing the HCCA option, this step corresponds to preparing a management frame named ADDTS (ADD Traffic Stream) request that includes the TSPEC structure prepared at step 610.

The ADDTS request is framed into a MAC data frame and sent to the Access Point—AP—at step 640.

Next, at step 650, the transmitting device waits for reception of corresponding ADDTS response from the AP. And upon receiving such ADDTS response, the Status Code included therein is analyzed to determine whether the reservation is accepted (status “success”) or not.

If the reservation is accepted, meaning for example that the requested bandwidth has been reserved in the network 19, the streaming of the encoded video data over the reserved channel can start at step 660.

If the reservation is refused, the transmitting device can create and send a modified stream reservation request, for example by modifying the requested bandwidth and modifying the codec control accordingly.

The process ends after step 660.

With reference to the right part of FIG. 6, the streaming of video data by a slice-oriented codec comprises a first step 670 in which the codec handles a new slice.

This may comprise receiving a slice of raw video data from a source module and then encoding the slice.

In a variant, this may comprise obtaining the slice number of the slice to process and then retrieving the corresponding encoded slice data in stored encoded frame data. If the stored encoded frame data have been obtained using encoding modes (e.g. inter prediction) other than the encoding mode to be used for video streaming (e.g. intra prediction only), these encoding modes are withdrawn by modifying the encoding of the data in such a way as to only keep the appropriate encoding mode for video streaming.

Based on the encoded slice data corresponding to the current slice, the codec creates encoded data packets at step 680, by packetizing the encoded slice data. The data packets include in particular this encoded slice data, as well as some packet or slice identifier and timestamps (like RTP does).

The created encoded data packets are then sent to the MAC layer for frame transmission at step 690, for example by implementing the MSDU, MPDU structures and possibly the A-MSDU, A-MPDU structures.

To provide a solution to the issue of increased error slice rate and degraded video rendering quality, embodiments of the invention assign each of the slices of a group of slices to a channel of a plurality of channels reserved in a communication network; and transmit, over each of the reserved channels assigned to, the encoded packets comprising only encoded slice data of the corresponding assigned slice or slices. By assigning the slices to the channels, several slice-based sub-streams of the video stream are formed and are transmitted over the corresponding reserved channel assigned to.

A plurality of channels is thus first reserved. In the above 802.11n approach, this means for example that a plurality of bandwidths (with other stream characteristics) is reserved, each of the reserved channels of said plurality being implemented through one or more MAC Protocol Data Unit, MPDU, slots within the transmitted aggregated-MAC Protocol Data Units, A-MPDUs, of the 802.11 protocol, wherein each MPDU includes an aggregated-MAC Service Data Unit, A-MSDU.

However other configurations may be implemented within the scope of the invention. For example, the reserved channels may be physical channels in the communication network, contrasting with the virtual MPDU slots of A-MPDUs transmitted over a single physical channel.

MIMO technology of the 802.11n protocol may be used to manage these several physical channels (in that case several radio channels). In this context, the encoded packets are framed into MAC Service Data Units, MSDUs, and are transmitted over the communication network using a wireless Multi In-Multi Out communication technology.

Also physical wired channels may be reserved. One or more virtual channels may also be reserved within each of these physical channels.

Such reservation of several channels may comprise obtaining stream characteristics of the video stream (made of the video frames) that has to be encoded and transmitted; determining a number Ns of channels based on at least one stream characteristic; generating and sending over the communication network Ns channel reservation requests based on the stream characteristics and the number Ns, to reserve said plurality of channels. Such a reservation process may be for example triggered when intercepting an original stream reservation (e.g. above TSPEC structure) made by an upper layer application for the purpose of transmitting a video stream. Of course, once the reservation process to reserve several channels according to the invention has been performed, a reservation acceptance message should be sent back to the upper layer application, so that the latter can thereafter send the data.

The bandwidth reservation for these transmission channels can also be revised dynamically to adapt to the real need of the video stream, i.e. to the changing amount of encoded slice data that depends for example on the content complexity of the frames. As briefly introduced above and described below with more detail, this dynamic adaptation may be provided by gathering encoding statistics from the encoded slice data to create, when appropriate, slice classes and to reserve corresponding transmission channels according to the encoding statistics.

When acting on the MAC layer to perform such operations, the control of the MAC layer Stream management can be done via the SME (Station Management Entity) interface.

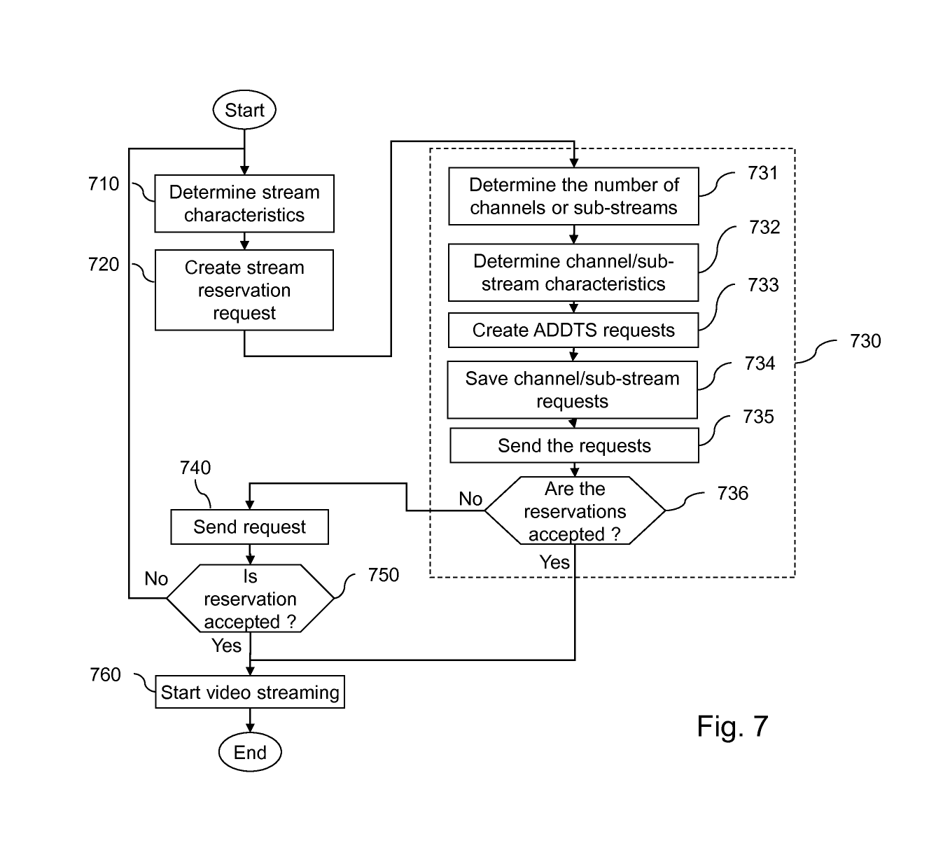

FIG. 7 illustrates a reservation process according to embodiments of the invention, based on the 802.11e approach as described above with reference to FIG. 6.

Steps 710, 720, and 740 to 760 are identical to steps 610, 620, and 640 to 660 of FIG. 6. However, upon intercepting the stream reservation request for the whole video stream, a new step 730 is conducted.

Step 730 comprises a first step 731 in which the number Ns of required channels (the number of sub-streams into which the video stream is intended to be split) is determined.

Typically, the number of required channels corresponds more or less to the number of slices that will be encoded between two successive accesses to the medium of the communication network (i.e. the slices to be sent at the next access to the medium). This is because the aggregation mechanisms occur on the data to be transmitted at the same medium access. By creating a number Ns of channels/sub-streams equal to the number of encoded slices, it is then guaranteed that each slice will not be aggregated with another one in the same A-MSDU, since the multi-stream capable MAC layer is allowed to aggregate within the same A-MSDU only encoded data packets from the same sub-stream (i.e. having the same TSID). The error slice rate is thus rendered as low as possible.

The TSPEC generated at step 720 according to conventional techniques contains a Maximum Service Interval (Msi) which gives the maximum time between two transmission opportunities, i.e. between two successive medium accesses.

Slice-oriented codecs generally produce encoded slices at a regular frequency (Fs=1/Ts; Ts meaning the average time in seconds to produce a new encoded slice). Typical value can be between 247 μs for a 1080p/60 fps video with a 16-line slicing (Ts=(1/60)/(1080/16)=247 μs) and 740 μs for a 720p/30 fps video with similar slicing.

The Msi/Ts ratio thus defines the average number of different slices that are transmitted on average at each new medium access. Thus, it is advantageous that the number of required channels depends on the ratio Msi/Ts.

In particular, when packetizing the encoded slice data provides encoded packets MSDUs aligned with the slices (situation of the top of FIG. 5), the number of channels may be equal to the ratio ┌Msi/Ts┐, where ┌.┐ is the ceiling function.

Conversely, when packetizing the encoded slice data provides encoded packets MSDUs not aligned with the slices, the plurality of channels may comprise an additional slice-independent reserved channel over which the encoded packets comprising encoded slice data of slices assigned to two (or more) different channels are transmitted, i.e. the mixing MSDUs. In that case, the total number of channels may be equal to ┌Msi/Ts┐+1.

After the number Ns of required channels has been determined, step 732 determines the characteristics of each of the Ns channels in order to create the corresponding TSPEC for reservation purpose.

Part of the characteristics of each channel is the same as some characteristics of the TSPEC produced at step 720. They can be retrieved directly from the latter. But some characteristics may differ, for example bandwidth characteristics and possibly the aggregation level. A specific TSID is also assigned to each respective channel and thus specified in the corresponding TSPEC.

The aggregation level should be disabled (i.e. no MSDU and MPDU aggregation allowed) for the above-defined additional slice-independent channel. This is because this additional channel will only be used to convey mixing MSDUs. In this context, it is worth keeping each of these mixing MSDUs in one independent MPDU so that the loss of one of them impacts the least number of slices. Due to the high number of slices concerned by this additional channel, attention should be paid to it so that there is little or no chance that non-concealable errors occur in it. For example very strong error concealment mechanisms could be implemented for that specific channel only.

Regarding the bandwidth of each required channel, an initial determination of each bandwidth may be conducted and then a dynamic adaptation of the bandwidths may also be performed as the frames are processed as described below, to follow as closely as possible the throughput of each slice-oriented sub-stream (i.e. the real needs of the video stream). This is because the initial determination as described below through an example does not provide the most efficient allocation of bandwidth for each of the sub-streams given their own content complexity.

The initial determination can be easy to be made in case of constant bit rate codec, or pseudo constant bit rate codec. This is because since such codec produces a bit stream that will have bounded variations around a fixed average value, the required bandwidth may be defined to be the same for each channel, equal to the total bandwidth defined in the original TSPEC of step 720 divided by the number Ns of channels. In that case, the variations around this value may be similar in percentages to those defined in the original TSPEC of step 720 (i.e. keeping the same ratio between the average and max throughput fields). This approach works for MSDUs aligned with the slices.

In case of non alignment of the MSDUs onto the slices, the bandwidth of the additional slice-independent channel is first determined. This determination comprises determining the ratio of the bandwidth used by the mixing MSDUs and applying this ratio to the total bandwidth defined in the original TSPEC of step 720. Since due to the non alignment, the last MSDU of each slice is supposed to include the first encoded slice data of the next slice, the ratio corresponds to the ratio of 1 compared to the average number of MSDUs used to convey the encoded slice data of a slice (for example 1 out of 5.6 in the above example with reference to FIG. 4).

Once the bandwidth of the additional slice-independent channel has been determined, it is subtracted from the same total bandwidth. The remaining part of the bandwidth is then allocated to each of the other required channels, for example as set out above in case of alignment of the MSDUs onto the slices.

Of course, to optimize the initial bandwidth repartition between the different channels and corresponding sub-streams, the initial process may take into account the encoder distribution (e.g. the repartition of the slice size according to the target bitrate settings) and/or user-selected shooting mode information (e.g. portrait vs. landscape, or sport event mode). For example, default or factory settings may provide default encoding statistics or normal distributions for each of the possible target bitrates or for each of the available shooting modes. Upon selecting the target bitrate and/or the shooting mode, the system may thus retrieve the corresponding statistics and infer an initial bandwidth repartition from them.

The same bandwidth for the additional slice-independent channel may be kept when the dynamic adaptation of the bandwidths as described below is implemented. The bandwidths of the other channels will then evolve, with their sum possibly departing from the above defined remaining part of total bandwidth.

The number of channels and the bandwidth for each channel may be determined once for the entire video stream and kept constant. However it may also or alternatively be periodically determined, for example for each new video frame, or for each new group of frames, known as a GOP (Group of Pictures). In addition, while a fair allocation of bandwidth between the channels has been described above, it may be adapted to various characteristics, in particular the bandwidths may be dynamically adapted to characteristics of the slices.

Of course, other approaches may be implemented to determine the number of required channels (for example it may be the number of physical transmission channels available) or to determine the channel characteristics (for example based on A-MPDU maximum size and/or on the ratio average slice size/maximum slice size) resulting in possible channels with different bandwidths.

Following step 732, step 733 consists in creating the ADDTS request for each of the Ns required channels, based on the corresponding TSPEC structures obtained at the preceding step.

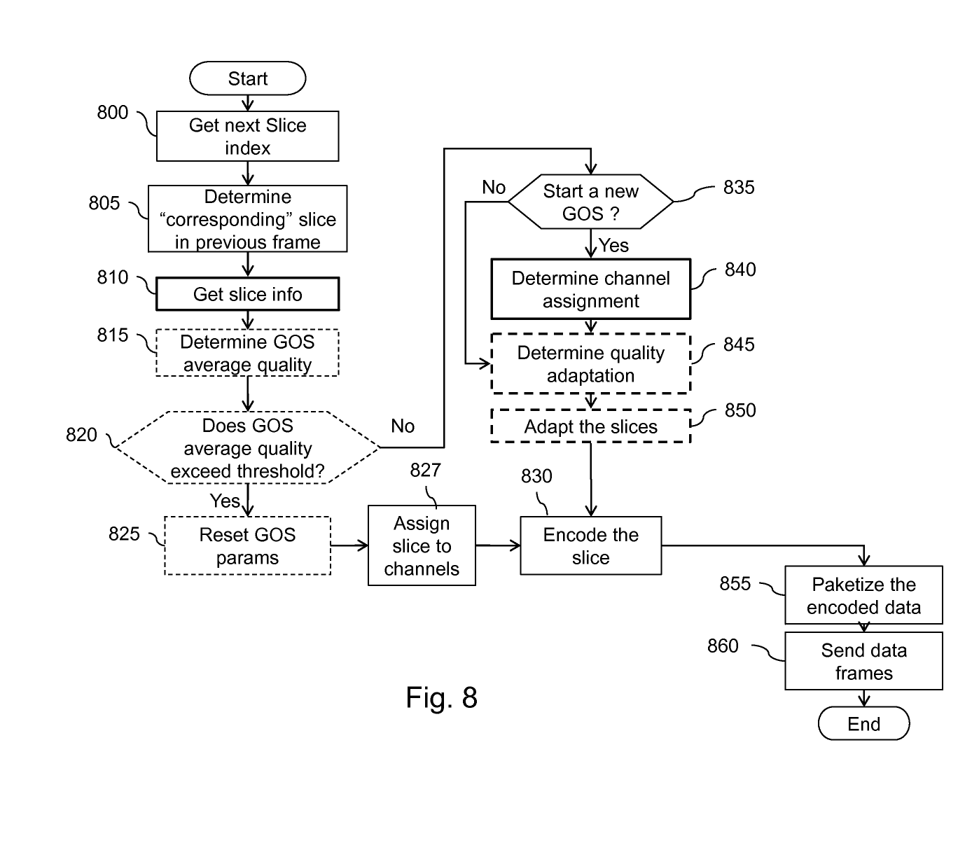

In step 734, the characteristics of each required channel may be saved in memory, in table SOT (standing for Sub-streams Occupancy Table), for future use as described below with reference to FIG. 8. The table SOT in memory may list the channels and corresponding bandwidth or equivalently the amount of data that can be transmitted at each access (i.e. corresponding bandwidth divided by Msi). Each channel in the table may also be provided with a Boolean field to indicate if a slice has already been assigned to the corresponding channel during the assigning operation.

Next the stream reservation requests (ADDTS frames) are sent to the Access Point at step 735.

At step 736, the MAC layer waits for ADDTS responses from the Access point, and checks each status of the responses to determine if the corresponding channel reservations have been accepted. Another Boolean “Status” in table SOT may be provided to indicate for each channel if the reservation has been accepted or refused.

When all the channel reservations have been accepted (all “Status” fields are “accepted” in table SOT), step 760 is executed to start the video streaming wherein the MSDUs of each slice are transmitted over the corresponding reserved channel, for example in the MPDU slot that corresponds to that reserved channel.

If all or some of the channel reservations failed (some “Status” fields are “refused”), then step 740 is executed to send the original stream reservation ADDTS defined at step 720. This results in deactivating the multi-channel mechanism according to the invention. This may for example happen when the amount of bandwidth requested for the original video stream is very close to the maximum available bandwidth. This is because in that case the small overhead due to the splitting into multiple channels can exceed the available bandwidth.

In an alternative to sending the original stream reservation ADDTS, a modification of the original stream may be conducted to reduce the required bandwidth (for example by re-executing step 710) as discussed above with respect to step 650.

Referring to FIG. 8, encoding and transmission methods in the context of the 802.11n protocol are now described. These methods are performed for each new slice in a current video frame, after the reservation of FIG. 7 has been completed. The number of slices within a video frame remains constant as specified above.

As will become apparent from below, the groups of slices that comprise the slices to be transmitted at each new access to the medium of the communication network 19 are determined progressively as the slices are encoded, depending on the time to encode these slices (the data to be transmitted must be already produced) and on the available bandwidth (to be able to send the data produced). The groups of slices, GOS, as they are produced and transmitted over the communication network 19, are indexed incrementally, i.e. from 1 to Ngos.

For the very first video frame of a video sequence, the state-of-the-art mechanism described above with reference to steps 670 to 690 is implemented and the resulting encoded slice data characteristics are stored in the SERT table.

The process starts at step 800 by obtaining the index of the next slice processed by the codec. This index is incremented from the first slice in the video frame to the last one.

At step 805, a slice that corresponds to the current slice is determined in the previous video frame. This is because assigning the slices to channels of said plurality may depend, according to embodiments of the invention, on characteristics of encoded slice data resulting from the encoding of corresponding slices in a previous video frame and on characteristics of said reserved channels.

Various approaches of “correspondence” between the two slices may be implemented. For example, the corresponding slices may be the slices having the same slice index in the current video frame and in the previous video frame. In a variant, they may be slices having the closest spatial position. This may be obtained by selecting, in the previous video frame, the closest slice (minimum motion vector) to the current slice, within their respective video frames.

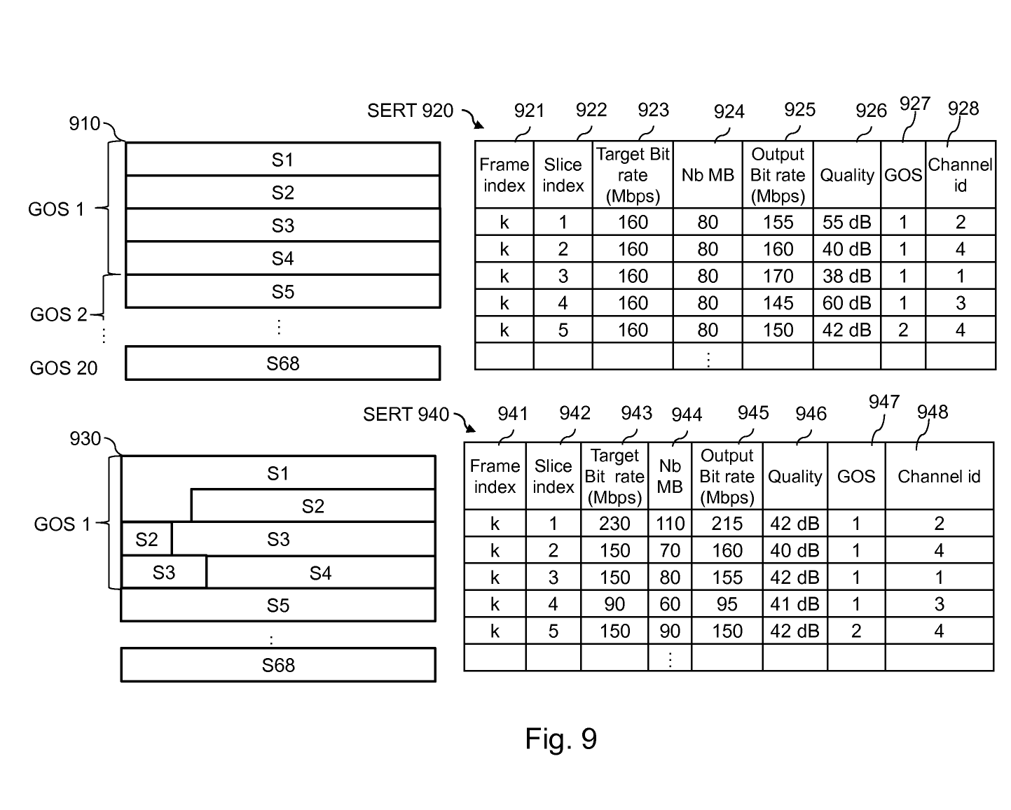

Next, at step 810, the slice information corresponding to that determined slice of the previous video frame is read from a table in memory, for example by using the slice index obtained at step 800 (if the corresponding slice of the previous video frame is the slice with the same slice index). This slice information comprises characteristics of the corresponding encoded slice data as shown in FIG. 9.

FIG. 9 represents two examples of video frame slicing and corresponding tables storing information about their encoding according to embodiments of the invention. For illustration purposes, it is considered here that a GOS comprises four slices.

The tables are referred to as Slice Encoding Result Table or SERT.

The filling of the SERT table is described later and comprises the results of the encoding of each slice. The table contains a line per slice in a video frame (typically 68 lines for a 1080p video frame), and each line is composed of eight columns.

The first column (921 and 941) is the index of the video frame, which identifies the video frame in a video sequence.

The second column (922, 942) represents the slice index in the current video frame (numbered from 1 to 68 for instance).

The third column (923, 943) stores the bit rate which will be provided to the codec as a target value for the encoding of the corresponding slice. In particular, this is the reserved bitrate or bandwidth corresponding to the channel to which the slice corresponding to the SERT line will be assigned, as described below. When implementing the dynamic adaptation of the bandwidths as described below, this value may thus evolve from video frame to video frame.

The fourth column (924, 944) indicates the number of macro-blocks defining each slice in the video frame. In the first SERT table 920, this number is the same since it corresponds to a state-of-the-art slicing into 1-macro-block-height line slices. In the second example 940, this number varies due to a slicing adaptation as described below with more detail.

The next two columns (925-926, 945-946) contain characteristics of encoded slice data resulting from the encoding, in particular information on the actual output bit stream rate and on an actual quality measurement (e.g. the Peak Signal to Noise Ratio).

As one may easily understand these characteristics may vary from one slice to another due to varying slice complexity, even though the same target bit rate has been specified to the codec (SERT 920). It may result in encoded slices having very different quality, thus in unpleasant video rendering. As will become apparent from below, the slicing adaptation according to embodiments of the invention makes it possible to average the PSNR or the like quality over the slices (SERT 940).

The seventh column (927, 947) stores the GOS index to which the slice defined in the SERT line belongs. The GOS index of the SERT can be set according to the medium access cadence: each time a set of slices is transmitted over the medium of the communication network, the GOS index is incremented. But this index can also be set in advance in the case of regular medium access (like TDMA for instance). This is because the size of each GOS is the same in that particular case.

The eighth column (928, 948) is used to store an identifier (TSID) of the reserved channel 190 to which the slice defined in the SERT line will be assigned and over which the corresponding encoded slice data will be transmitted. Because each channel can have a different reserved bandwidth, the assigning of a slice to a channel is of particular importance as explained below with respect to step 840.

When only encoding characteristics of one previous video frame are needed, only two SERT tables are used: the one of the previous video frame and the one of the current video frame.

At step 810, the output bit rate 925-945 and/or the quality value 926-946 are consequently retrieved.

At optional step 815, there is determined an average encoded slice quality value resulting from the encoding of a corresponding group of slices in the previous video frame. The “corresponding” group of slices may be the GOS having the same GOS index (column 927 or 947) as the current GOS being processed (i.e. to which the current slice belongs).

The PSNR quality values are thus retrieved from the SERT table for that corresponding GOS (in the example, there are four values retrieved), and are averaged to obtain the GOS average quality value.

At optional step 820, this GOS average quality value is compared to a threshold value, for example 45 dB or 50 dB). The aim of step 820 is to detect when there are abrupt changes between successive video frames, for example changes in contents of video frame, textures, etc. This is because the GOS parameters, such as slice sizes and bandwidth of channels that may be dynamically adapted, are no longer adapted to the slice content. It is to be noted that such computation may be done in advance for the video frames based on the GOS index only. In an optimized implementation, the computation is then performed during the inter-frame time period.

Since this approach depends on an optional implementation of the slicing adaptation and bandwidth dynamic adaptation, steps 815 and 820, as well as below steps 825-845-850 are optional. Without adaptation, the next step is directly step 835.

When the GOS average quality is bad (below the threshold), the GOS parameters are reset at step 825, for example by restoring a fair slice size of 80 macro-blocks and fair target bit rate of 160 Mbps (the situation of SERT 920), for example according to a state-of-the-art mechanism.

In that case of GOS parameter reset, the same as for to the very first video frame of the video sequence is performed, i.e. the state-of-the-art mechanism described above with reference to steps 670 to 690 is implemented and the resulting encoded slice data characteristics are stored in the SERT table.

Subsequent to step 825, this comprises step 827 of assigning the slices of the GOS to the channels, for example statically or as described below with respect to step 840. Then, it comprises step 830 of encoding the current slice (similar to step 670 of FIG. 6).

For purposes of illustration of the resetting the GOS parameters, the slices with a fixed slice size of 80 macro-blocks for example are assigned to the transmission channels with a target bitrate for the encoder that corresponds to the bandwidth of the assigned-to channel. In a variant, the same target bitrate for the encoder may be set to each slice, no matter how the bandwidths are spread over the plurality of transmission channels, Selecting one or the other of these two variants may be based on the quality of the network (ratio of unsuccessful transmissions compared to the number of transmissions in history).

When the GOS average quality is good (above the threshold), it is determined whether the current slice starts a new GOS, at step 835. This may be simply done by comparing the current GOS index to the GOS index of the previous slice. For example, in the case of SERT in FIG. 9, each new fifth slice starts a new GOS.

Steps 835 to 850 perform slicing adaptation of the video frame when it is implemented. This adaptation aims at smoothing the quality amongst the encoded slices while maintaining the average bit rate for a portion of the video frame, generally by progressively reducing the encoding quality of the slices having a high quality, and conversely increasing the encoding quality of the slices having a low quality.

In case of a new GOS, the process continues at step 840 where each of the slices of the new GOS is assigned to a channel of the plurality of channels reserved as described above with reference to FIG. 7. Here the assigning depends on encoded slice data characteristics resulting from the encoding of the corresponding slices in the previous video frame and on the characteristics of the reserved channels, such as available bandwidth stored in the above SOT table. For each slice, the channel the best adapted to the slice is thus determined.

When all the target bit rates of the slices of the GOS are equal to an average value (for example because all the reserved channels have the same bandwidth, possibly after a GOS parameter reset), a very crude assigning approach may consist in randomly assigning each slice to one of the reserved channels or in assigning the slices according to a round-robin scheduling.

However other smarter methods may also be implemented, in particular when the reserved channels have different bandwidth (either from the initial reservation or from a dynamic adaptation), the assigning takes into account the encoding performance in the previous video frame. For example, the slices may be ranked in a slice list according to an encoded slice quality value or an encoded slice output bit rate value of the encoded slice data resulting from the encoding of their corresponding slices in the previous video frame; the channels of said plurality may also be ranked in a channel list according to their respective reserved channel bandwidths; and the assigning of the slices to channels may then follow the ranks of the ranked slice list and of the ranked channel list.

The slices having the biggest throughputs may thus be assigned to the channels having the biggest bandwidths.

Alternatively the slices with the best quality for the previous video frame are assigned to the channel having the smallest available bandwidth (because it may be considered that there is room for reducing the size of the bitstream while keeping a good quality), and conversely the slices with the worst quality for the previous video frame are assigned to the channel having the biggest available bandwidth.

Once the assigning has been performed, the assigning result is stored in the SERT table by writing the index of the assigned-to channel in the column 928 or 948. The first Boolean field in the SOT table may also be marked each time a slice is assigned to the channel corresponding to the entry of that table.

Further to step 840 or if the current slice does not start a new GOS (meaning that a channel assigning has already been performed for the current GOS), step 845 consists in determining a level of quality adaptation for the current slice. This intends to reflect whether or not this slice (meaning the corresponding slice in the previous video frames) has been efficiently encoded in the previous video frames or not, in which case its proper encoding may be adapted using for example the slicing adaptation.

This may be done by determining whether the encoded slice quality value resulting from the encoding of the corresponding slice in the previous video frame is higher or lower than an average encoded slice quality value resulting from the encoding of a corresponding group of slices in the previous video frame.

In practice the quality value (column 926 or 946) retrieved at step 810 for the current slice is compared to the GOS average quality value obtained at step 815. A resulting ratio is obtained and input to the next step 850 which performs the slicing adaptation.

The slicing adaptation of step 850 is intended to modify the slice size to fit with the determined level of quality adaptation.

In one embodiment, it comprises reducing the size of the current slice by a given number of macro-blocks of pixels if it is determined that the encoded slice quality value is lower than the average encoded slice quality value; or increasing the size of the slice by the given number of macro-blocks of pixels if it is determined that the encoded slice quality value is higher than the average encoded slice quality value. That means that the slice size set in column 924 or 944 is increased or decreased by said given number, for example by two macro-blocks, to avoid abrupt and major modification of the slice sizes. But one may easily understand that if the modification of the slice size is not sufficient this time, it will be increased by one new step (+/−two macro-blocks) when processing the next video frame.

As discussed above, the number of macro-blocks and possibly of slices in the video frame should remain constant in order to facilitate synchronization issues between the transmitting device and the receiving device. In this context, where a modification of a slice size occurs, an inverse modification of the size of another slice must be performed in the same proportion.

For example, when the size of a slice is modified, the next slice in the current video frame is inversely modified, to ensure the same number of slices is kept within the current video frame. In a variant, when macro-blocks are added to (respectively deleted from) the current slice, the slice [possibly only in the current GOS] with the worst (respectively the best) quality is decreased (respectively increased) by the same number of macro-blocks.

Other approaches that need more computation and on-the-fly analysis of the encoded slices may also be implemented. For example the encoding result (i.e. encoding characteristics) of each macro-block could be stored in memory when encoding. It would then be possible to identify the size of the slices neighboring each slice, and then to determine the impact of removing one macro-block from a slice and adding it to a neighboring slice (e.g. to increase by one the number of macro-blocks in the previous slice and increase by one the number of macro-blocks in the next slice).

Another approach can be based on slice shape adapting. It is possible not to modify the slice size or to modify it to a lesser extent than described above, but the shape of the slice may be modified to include more or fewer complex-to-encode macro-blocks depending on the quality of the corresponding slice in the previous video frame.

Next to step 850, the current slice is encoded at step 830 using the encoding parameters (columns 923/943 and 924/944 of the assigned-to channel).

The resulting encoded slice data are then packetized into encoded packets at step 855 (similar to step 680 of FIG. 6). However, the encoded packets indicate the channel identifier TSID of the corresponding assigned-to channel.

The encoded packets are transmitted to the MAC layer at step 860 in which they are processed. In particular, regarding the 802.11n protocol, the MAC layer frames the encoded packets into MSDUs and aggregates the encoded packets into encoded data frames A-MSDUs (by aggregating the corresponding MSDUs), wherein aggregating is a channel-oriented aggregating operation that aggregates, into the same data frame A-MSDU, only encoded slice data of the slice or slices (i.e. MSDU) assigned to the same channel.

Still at step 860, the data frame A-MSDUs are transmitted over the reserved channel assigned to. For example, in a first phase, they are input in the buffers VCᵢ from where each A-MSDU is put into a PHY data frame aggregating MPDUs, at the MPDU slot that has been reserved for its respective channel assigned to. The PHY data frame comprising A-MSDU of several slices in corresponding MPDU slots is then transmitted over a single physical channel 190 of the network at the next medium access.

It is recalled here that, in case of non alignment of the MSDU onto the slices, an additional slice-independent channel is used to transmit the MSDU comprising encoded slice data of two or more slices, as independent MPDUs without A-MSDU or A-MPDU aggregation.

The result of the slicing adaptation is illustrated through FIG. 9 in which 930 shows an example of slicing obtained after encoding several video frames (i.e. after several occurrences of slicing adaptation) and SERT table 940 shows an example of the resulting encoding characteristics. It may be observed that the encoding quality of the slices has been smoothed around 41-42 dB. The video rendering is thus more pleasant for the viewers.

Above has been described a method for transmitting video frame data over a communication network that ensures encoded slices of video frames are not split over several transmission channels, which would lead to higher slice error rate.

The method is slice-oriented to divide the initial video into several sub-streams where preferably non consecutive slices are included in the same sub-stream. It is then possible to transmit the content of each sub-stream on a given reserved channel.

In addition, to smooth the quality of the encoded slices while keeping the same assigning of the slices to the reserved channels, the method dynamically adapts the frame slicing (i.e. the slice sizes in number of macro-block or the slice shapes) based on the compression performance when encoding the corresponding portion of the previous video frame. The least complex slices may thus be increased in size so as to better use the bandwidth of the corresponding channel assigned to. Similarly, the most complex slices may be reduced in size so as to improve their rendering quality while using the same bandwidth for the corresponding channel assigned to. In a variant, the slice-to-channel assignment could be modified to provide a better rendering quality.

The method particularly applies to a live video streaming system in which the codec must ensure a constant amount of time for the encoding of a group of slices.

While above a dynamic adaptation of the frame slicing at a one-frame rate has been described, embodiments may comprise dynamically adapting the reserved bandwidths in the transmission channels 190, for example at a lower rate. This is because the bandwidth dynamic adaptation should mirror significant changes in the content of the video stream, i.e. generally when a new video sequence in the bitstream occurs (i.e. after a large number of video frames).

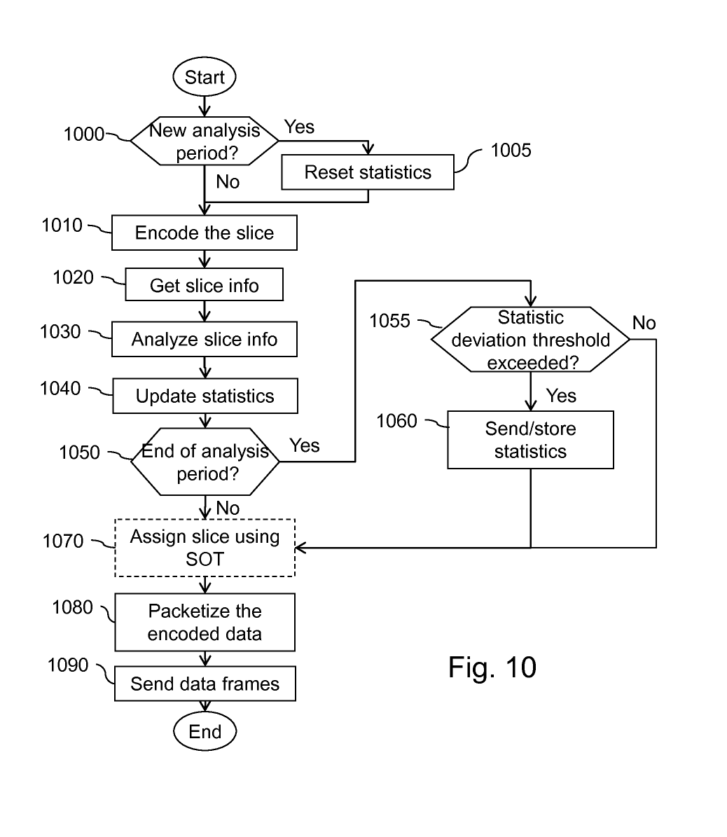

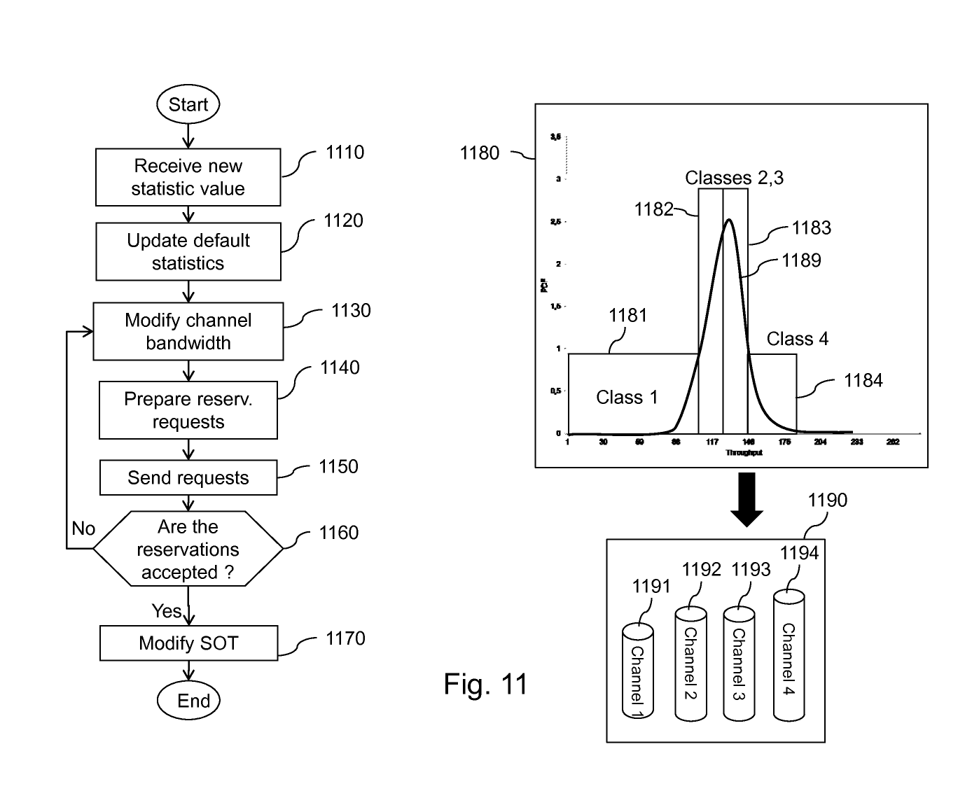

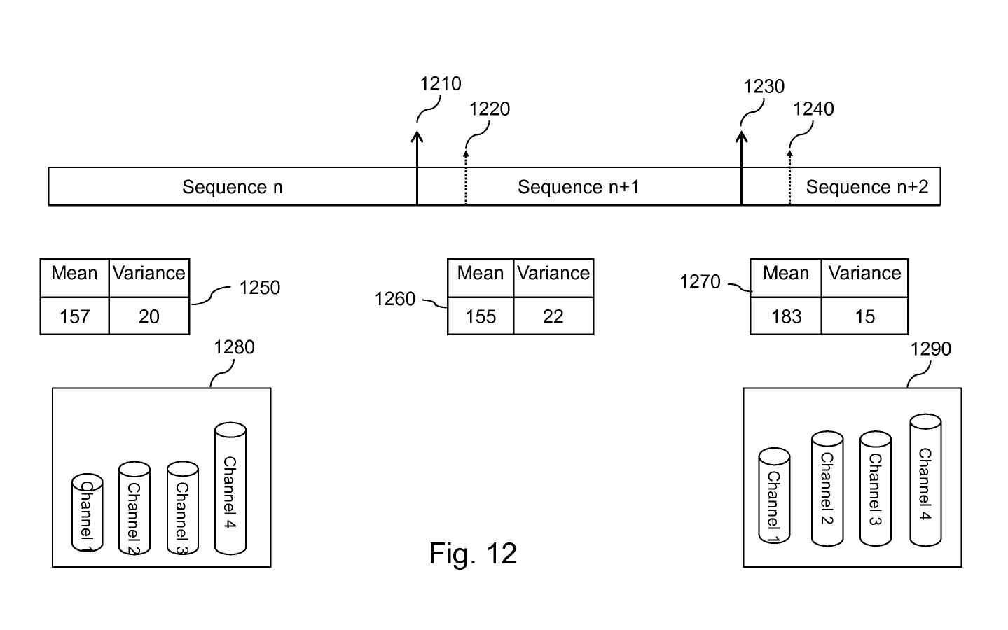

FIGS. 10 to 12 illustrate such dynamic adaptation of the channel bandwidths according to the video stream needs, wherein FIG. 10 illustrates a streaming process for video data itself according to embodiments of the invention, based on the 802.11e approach as described above with reference to FIG. 6; FIG. 11 illustrates the dynamic reallocation of bandwidth for the plurality of transmission channels 190; and FIG. 12 illustrates the bandwidth dynamic adaptation in the case of several successive sequences in a video stream.

As introduced above, the bandwidth dynamic adaptation is based on encoding statistics gathered from the encoded slice data of first slices. FIG. 10 illustrates the gathering of encoding statistics within the encoding and transmission processes.

Compared to FIG. 6, FIG. 10 shows additional steps that perform the statistics gathering with the aim of updating the bandwidth allocation. They can be merged with the steps of FIG. 8. In particular, most of the additional steps follow the encoding of each slice, in such a way that they may be integrated after step 830 of FIG. 8.

This process is performed for each new slice in a current video frame, after the reservation of FIG. 7 has been completed or the update of bandwidth allocation has been performed as described below with reference to FIG. 11.

Steps 1010, 1080 and 1090 are similar to steps 670, 680 and 690 of FIG. 6 or step 830, 855 and 860 of FIG. 8, depending for example on whether the slicing adaptation is implemented.

The streaming process with bandwidth dynamic adaptation starts at step 1000 by checking whether or not a new analysis time period is starting. The analysis time period is used to gather encoding statistics from the slices encoded during that new analysis time period before triggering an update of the transmission channel bandwidth allocation.

A new analysis time period may start when detecting a change of sequence in the video frames. For example, this may occur when a video shot drastically changes from one video frame to the following one. For example this may be made by comparing the pixel intensity or the three pixel components of each pixel between successive video frames or part of them (e.g. at a GOS level or a slice level) A difference higher than a predefined threshold may correspond to the detection of such a change.

In another example, the new analysis time period may start directly at the end of the previous analysis time period. That means that there is a continual gathering and analysis of the encoding statistics as described below.

When a new analysis time period starts, the encoding statistics obtained during the last analysis period are reset at step 1005. It is important to regularly reset the current encoding statistics so that the analysis exactly mirrors the current part of the video stream. Otherwise, the current analysis can be expected to be smoothed by old encoding statistics that no longer concern the current video sequence.

Next, at step 1010, the current slice is encoded, generating corresponding encoded slice data.

At step 1020, information about the encoding process is obtained. This may comprise the type or types of prediction used, the slice size as defined in SERT table, the size of macro-blocks as defined by the encoder, etc.

At step 1030, this information is used to analyze the encoded slice data in order to extract encoding statistics.

For example, the bitstream sizes of the encoded macro-blocks or of the encoded slice (i.e. the bitstream size of the corresponding encoded data) are gathered and stored starting from the beginning of the current analysis time period. From these stored bitstream sizes, encoding statistics may be constructed: the encoding statistics may comprise the number of slices or macro-blocks as a function of the bitstream size or bitrate of the corresponding encoded data. One may note that the bitstream size and bitrate are directly linked together by bitrate≈bitstream size/Ts.

Preferably, the encoding statistics comprises parameters defining a modeling normal (or Gaussian) distribution that models said number of slices or macro-blocks as a function of the bitstream size or bitrate of the corresponding encoded data. In particular, the parameters include the mean and the variance of said modeling normal distribution. Conventional fitting techniques to fit the modeling normal distribution onto the gathered bitstream sizes may be used to determine the mean and variance values.

FIG. 11 shows an example of modeling normal distribution.

At step 1040, the newly determined mean and variance are used to update mean and variance values associated with the current analysis time period.

At step 1050, it is checked whether or not the current analysis time period has ended. For example an analysis time period may be defined for a predefined time period, for example for an integer number of video frames, such as 5 or 10 video frames.

In a variant of defining successive analysis time period, a sliding analysis time window is defined with a time width substantially equal to the analysis time period defined above. In that case, the gathered encoding statistics are the statistics concerning the slices within this sliding analysis time window. This necessitates regular updating of the statistics at each video frame for example, to remove the oldest ones (corresponding to the video frame that is going out of the sliding window) and to add the statistics of the video frame just being encoded. In this situation, there is no checking step 1050, but the process directly passes from step 1040 to step 1055.

At step 1055, it is checked whether or not these parameters (mean and variance) of the encoding statistics gathered during that analysis time period exceed at least one threshold value. For example one threshold value may be defined for each of these two parameters.

Since this test 1055 is intended to compare the currently-gathered statistics with default statistics based on which the currently used bandwidth allocation has been made in order to trigger or not trigger an update of the transmission channel bandwidth allocation, the threshold values are defined based on the corresponding parameters in the default statistics. A maximum mean deviation and a maximum variance deviation may thus be defined.

If the deviation of one or both statistic parameters exceeds the corresponding maximum deviations, the currently gathered statistics (i.e. the two parameters) are sent to a channel reservation module at step 1060 for bandwidth reallocation. What happens when such statistics are received is described below with reference to FIG. 11.

If the analysis time period has not ended or after step 1060, step 1070 is executed. Step 1070 consists in assigning the current slice to one of the reserved channels, for example by using the SOT table to determine which reserved channel is the best adapted to the bitstream size of the encoded slice data.

Of course, if the steps of FIG. 8 are implemented, this assignment may have already been performed at step 840 when processing the first slice of the GOS.

Next, the encoded slice data are packetized into encoded packets at step 1080 as explained above (step 680 or 855). Further to step 1080, the encoded packets are transmitted to the MAC layer at step 1090 that transmits them over the network 19 as explained above (step 690 or 860).

This process of gathering and analyzing encoding statistics has been described in an on-the-fly approach, i.e. as the video stream is being encoded and simultaneously transmitted over the network: the encoding of the first slices and the obtaining of corresponding encoding statistics are performed while transmitting the encoded data of already encoded slices.

In a variant concerning an offline approach (the video stream is encoded for storage purposes, its streaming being postponed), step 1060 no longer sends the current two statistics parameters but may store them together with the video stream. This means that the current values of the statistics parameters are stored or attached to the resulting encoded video frames each time these values exceed the above thresholds.

In particular, these values may be attached to the analyzed portion of the video portion (i.e. the video frames corresponding to the analysis time period), for example they could be inserted directly into the video bitstream as a new kind of delimiter. In a variant, they may be appended in another file with temporal references to the video stream.

These statistics values embedded in the stored video stream (or appended to it) may thus be used and sent to the channel reservation module when deciding to stream the video, to dynamically adapt the bandwidth of the transmission channels 190, as described below.

Some information about the encoding process obtained at step 1020 may be used to adapt the statistics to the kind of encoding which will be used during the video streaming. For example, at least two sets of encoding statistics may be obtained when encoding the first slices, the sets corresponding to respective encoding modes (for example statistics about inter-prediction based encoding and other statistics about intra-prediction based encoding). In that case, when deciding to stream the video, the method may further comprise updating the set of encoding statistics of an encoding mode based on which the encoded data are transmitted with the set of encoding statistics of at least one other encoding mode.

Keeping with the example of the stored encoded video before it is streamed (offline approach), it is worth using inter prediction in addition to intra prediction for storage purposes. This is because this combination provides a high compression rate and thus a maximum reduction in memory space needed on the data storage media.

However, when deciding to stream the stored video, only the intra prediction mode should survive in the streamed encoded data. This may be done by transcoding the video before streaming. Only keeping the intra prediction provides low latency and improved protection of the predicted video data.

To provide appropriate encoding statistics for the bandwidth dynamic adaptation, it is useful to create a single set of encoding statistics from the encoding statistics of the inter mode and the encoding statistics of the intra mode.

This may be done by integrating the first ones into the second ones. Several approaches may be used and/or combined:

use a multiplier coefficient to modify the intra mode statistics by the inter mode statistics. For example, the typical average ratio between inter and intra prediction coding is Inter=⅛ Intra;

a motion vector defined in the inter prediction may be used to refine the inter/intra ratio. This is because the inter macro-block depends on the “parent” intra macro-block residue (or size) selected for inter prediction;

in the particular case of H264 (used to create the highly compressed video to store), the intra weight is computed during the prediction process even if the inter node is finally chosen. This is because all predictions, included intra, are tested in order to find the least expensive (response to rate/distortion constraints). Statistics about intra mode are thus known.

With reference to FIG. 11, there is now described the dynamic reallocation of bandwidth for the plurality of transmission channels 190 when new statistics (e.g. new values of mean and variance) are received by the channel reservation module (at step 1060). This process is thus iteratively performed, i.e. each time new statistics are received.

The left part of FIG. 11 is a flowchart illustrating the steps for bandwidth dynamic reallocation, while the right part shows how new bandwidths are defined based on the gathered statistics.

The bandwidth dynamic reallocation process starts at step 1110 by receiving new statistic values from the analysis process (from step 1060).

At step 1120, the default statistics (based on which the previous bandwidth allocation modification has been made) are updated with the current statistics received at step 1110.

At step 1130, the new characteristics, in particular the new bandwidth, of each Ns channels (or Ns−1 if an additional slice-independent channel is provided, the bandwidth of which should be kept constant) are determined in accordance with the default statistics (comprising the newly received ones given step 1120).

Numeral 1180 shows encoding statistics gathering the number of slices function of the bitstream size of the encoded slice data. The modeling normal distribution defined by the mean and variance values received at step 1110 is referenced 1189.

From this modeling normal distribution, there is built a plurality of Ns classes as a function of at least one item of characteristic information (here the bitstream size or bitrate of encoded slice) of this modeling normal distribution. Each class is associated to one of the Ns transmission channels.

In the present example where four slices form a GOS (Ns=4), the range of encoded slice bitstream sizes (i.e. in bits) of the obtained statistics is cut into a respective plurality of four subparts 1181-1184 based on the mean and the variance of the modeling normal distribution. For example, the total range of the normal distribution may be approximated to the interval [−3σ,+3σ] where σ² is the variance, and the four subparts are defined by their min and max encoded bitstream sizes.

The cutting is performed in order to homogeneously distribute the slices, i.e. for each transmission, every channel should convey one slice among the four.

Each subpart defines a class for the slices and is associated with one of the transmission channels, for example the part 1 1181, part 2 1182, part 3 1183 and part 4 1184 with respectively the channel 1 1191, 2 1192, 3 1193 and 4 1194.

The new bandwidth of a transmission channel is based on the maximum bitstream size of the subpart defining the associated class. For example, the bandwidths of the four transmission channels or classes may be μ−0.67σ, μ+0.67σ, μ+0.67σ and μ+3σ, where μ is the mean of the modeling normal distribution. In a slight variant, the four bandwidths are μ−0.67σ, μ, μ+0.67σ and μ+3σ.

In the example of the statistics 1180 in case of four channels 1191, 1192, 1193 and 1194, the new bandwidth of the channel 1191 is set to 100 Mbps as defined by the boundary between 1181 and 1182. The channels 1192 and 1193 are set to 146 Mbps as defined by the boundary between 1183 and 1184. Two channels are defined with the same new bandwidth in order to handle the maximal occurrence of the normal distribution. The last channel 1194 is initialized with the maximum bandwidth of the normal distribution 180 Mbps (given the +3σ boundary).

Once the new bandwidths have been defined for the Ns classes and corresponding transmission channels, a set of Ns channel reservation requests is prepared at step 1140, similarly to step 733 above. For example, the requests could be ADDTS request frames including a TSPEC filled with the values determined at step 1130. The TSPEC should contain the same information as the TSPEC used for the Stream creation at step 720 (in particular the same TSID), but updated with specific bandwidths as just determined at step 1130. This procedure is called TS renegotiation in the standard IEEE 802.11e.

Then the stream/channel reservation requests (ADDTS frames) are sent to the Access Point at step 1150, similarly to step 735.

At step 1160 (similar to step 736), the MAC layer waits for ADDTS responses from the Access point, and checks each status of the responses to determine if the corresponding channel reservations have been accepted.

When all the channel reservations are accepted, the process goes to step 1170 where the SOT table (and SERT table) is updated to mirror the new reserved bandwidths and so the size of each channel used to packetize encoded slice data at step 1080.

If all or some of the channel reservations failed, the process could try again to make new reservation requests for the channels for which the prior reservation failed. The new reservation requests may be established with new channel requirements.

In case of successive reservation failures for the same channel, the process can keep the non-optimized bandwidth allocation and modify the target bitrate of the codec to adjust it to the new channel characteristics.

When the bandwidth dynamic adaptation as described above is implemented, the assignment of the slices to channels as explained with reference to step 840 may also be considered as an assignment of slices to the above corresponding classes.

FIG. 12 illustrates an example of the modification of the bandwidth allocation during a video streaming of several successive video sequences.

The Figure shows a video part made up of three video sequences: n, n+1, n+2. Conventional techniques make it possible to detect successive sequences in a video stream.

The characteristics of encoding statistics that correspond to the sequence n are shown in table 1250. The mean p and variance σ² (σ is the standard deviation) of the modeling normal distribution equal respectively 157 Mbps and 20 Mbps (only the intra coding mode is considered here).

It is well known that the probabilities of the normal distribution are the following:

P[μ−σ;μ+σ]≈68%

P[μ−2σ;μ+2σ]≈95%

P[μ−3σ;μ+3σ]≈99.7%

Thereby, 6σ may be considered as approximately encompassing all the slice sizes resulting from the encoder.

When four channels are defined, four classes are defined from this modeling normal distribution based on the mean and variance values. A fair splitting of the 66 wide range may be done given that 25% corresponds to 0.67σ.

A first class is defined from μ−3σ (or 0) to μ−0.67σ, thus encompassing the slice sizes of 25% of the encoded slices over the analysis time period. The allocation of the corresponding first channel 1 is the maximum bitrate of the first class, i.e. μ−0.67σ (157−0.67*20^{0.5}=154 Mbps).

A second class is defined from μ−0.67σ to μ, thus encompassing the slice sizes of 25% of the encoded slices over the analysis time period. The allocation of the corresponding second channel 2 is the maximum bitrate of the second class, i.e. μ (157 Mbps).

A third class is defined from μ to μ+0.67σ thus encompassing the slice sizes of 25% of the encoded slices over the analysis time period. The allocation of the corresponding third channel 3 is the maximum bitrate of the third class, i.e. μ+0.67σ (157+0.67*20^{0.5}=160 Mbps).

In a slight variant, the allocation of these two central channels/classes may be identical so that the system can manage two big slices having a high probability of occurrence. In that case, the second and third channels have the same bitrate of μ+0.67σ (157+0.67*20^{0.5}=160 Mbps). This is appropriate when the variance is low, because the repartition depends on the global shape of the normal distribution (flat with a high variance or thin with a low variance.

A fourth class is defined from μ+0.67σ to μ+3σ thus encompassing the slice sizes of 25% of the encoded slices over the analysis time period. The allocation of the corresponding fourth channel 3 is the maximum bitrate of the fourth class, i.e. μ+3σ (157+3*20^{0.5}=170 Mbps).

The above example is based on four channels. When this number is different or varies as the video frames are processed, the fair splitting of the 6σ wide range may require having in (read only) memory a table that stores the value of the normal distribution.

For the sequence n and according to the requirements of the table 1250, the four channels are illustrated by 1280 (height of the drawings in proportion of the corresponding allocated bandwidth).

Upon detecting a change of sequence 1210, the process starts an analysis time period of several video frames in order to gather encoding statistics defining the characteristics of the new sequence n+1. The end of the analysis time period is referenced 1220 (detected at step 1050).

At this time 1220, the characteristics 1260 of the sequence n+1 are available (mean and variance).

They are compared to the previous ones (i.e. 1250) at step 1055.

As the differences between the mean and variance values of table 1250 and table 1260 are really slight (not above corresponding thresholds), the bandwidth reallocation is not required.

At time 1230, a new video sequence (n+2) is detected. The process starts a new analysis time period of several video frames in order to gather encoding statistics defining the characteristics of the new sequence n+2. The end of the analysis time period is referenced 1240 (detected at step 1050).

At this time 1240, the characteristics 1270 of the sequence n+2 are available (mean and variance).

They are compared to the previous ones (i.e. 1250) at step 1055.

In this example, the differences of mean and variance values between 1250 and 1270 exceed respective threshold values, and a bandwidth renegotiation is executed (process of FIG. 11).

Numeral 1290 represents the resulting new bandwidth allocation. Since the mean μ has increased, the bandwidths allocated to channels 1, 2 and 3 have also increased.

But since the variance value σ² has decreased (constant peak bit rate), the bandwidth allocated to the channel 1 remains the same.

Although the present invention has been described hereinabove with reference to specific embodiments, the present invention is not limited to the specific embodiments, and modifications which lie within the scope of the present invention will be apparent to a person skilled in the art. Many further modifications and variations will suggest themselves to those versed in the art upon making reference to the foregoing illustrative embodiments, which are given by way of example only and which are not intended to limit the scope of the invention as determined by the appended claims. In particular different features from different embodiments may be interchanged, where appropriate.

1. A method of transmitting video frame data over a communication network, the method comprising:
obtaining a group of coding units of a current video frame;
assigning each of the coding units to a channel of a plurality of channels reserved in a communication network;
encoding each coding unit, based on channel characteristics of the channel to which it has been assigned, to obtain encoded data;
packetizing the encoded data into encoded packets; and
transmitting, over each of the reserved channels assigned to, the encoded packets comprising only encoded data of the corresponding assigned coding unit or units.

2. The method of claim 1, wherein the coding units are slices of macro-blocks of pixels.

3. The method of claim 1, wherein the group of coding units comprises the next slices of the current video frame that have to be transmitted at the next access to the communication network.

4. The method of claim 3, wherein the number of channels within said plurality of channels depends on the ratio Msi/Ts, where Msi is a maximum time between two successive accesses to the communication network and Ts is an average slice encoding time to encode one slice.

5. The method of claim 1, wherein assigning the coding units assigns non consecutive coding units of the group of coding units to the same channel.

6. The method of claim 1, further comprising aggregating the encoded packets into encoded data frames, wherein aggregating is a channel-oriented aggregating operation that aggregates, into the same data frame, only encoded data of the coding unit or units assigned to the same channel.

7. The method of claim 6, wherein the encoded packets are framed into MAC Service Data Units, MSDUs, and the data frame comprises an aggregated-MAC Service Data Unit, A-MSDU, of the 802.11 protocol.

8. The method of claim 6, wherein the reserved channels of said plurality are MAC Protocol Data Unit, MPDU, slots within an aggregated-MAC Protocol Data Unit, A-MPDU, of the 802.11 protocol, wherein each MPDU includes an aggregated-MAC Service Data Unit, A-MSDU.

9. The method of claim 1, wherein assigning the coding units to channels of said plurality depends on characteristics of encoded data resulting from the encoding of corresponding coding units in a previous video frame and on characteristics of said reserved channels.

10. The method of claim 9, wherein the coding units are ranked in a coding unit list according to an encoded quality value or an encoded output bit rate value of the encoded data resulting from the encoding of their corresponding coding units in the previous video frame; the channels of said plurality are ranked in a channel list according to their respective reserved channel bandwidths; and the assigning of the coding units to channels follows the ranks of the ranked coding unit list and of the ranked channel list.

11. The method of claim 1, further comprising modifying the size of coding units before encoding them, wherein modifying the size of a coding unit in the current video frame depends on an encoded quality value of the encoded data resulting from the encoding of a corresponding coding unit in a previous video frame.

12. The method of claim 11, wherein modifying the size of a coding unit of said group comprises:
determining whether the encoded quality value resulting from the encoding of the corresponding coding unit in the previous video frame is higher or lower than an average encoded quality value resulting from the encoding of a corresponding group of coding units in the previous video frame; and
reducing the size of the coding unit by a given number of macro-blocks of pixels if it is determined that the encoded quality value is lower than the average encoded quality value; or increasing the size of the coding unit by the given number of macro-blocks of pixels if it is determined that the encoded quality value is higher than the average encoded quality value.

13. The method of claim 1, further comprising obtaining stream characteristics of video stream made of video frames; determining a number Ns of channels based on at least one stream characteristic; generating and sending over the communication network Ns channel reservation requests based on the stream characteristics and the number Ns, to reserve said plurality of channels.

14. The method of claim 1, wherein encoding each coding unit uses intra prediction within the respective coding unit.

15. The method of claim 1, wherein the channel characteristics based on which each coding unit is encoded comprises reserved bandwidth.

16. The method of claim 1, further comprising:
obtaining encoding statistics from the encoded data of first coding units;
creating a plurality of classes as a function of at least one item of characteristic information of the obtained statistics;
reserving a plurality of transmission channels for the respective plurality of classes, each channel having a reserved bandwidth that depends on a value of the characteristic information for the respective class;
assigning second coding units each to one of the classes; and
transmitting the encoded data of each second coding unit over the reserved channel corresponding to the class to which said each second coding unit is assigned;
wherein the encoding of the second coding units depends on the reserved bandwidths of their respective transmission channels.

17. A transmitting device for transmitting video frame data over a communication network, the device comprising:
an input module for obtaining a group of coding units of a current video frame;
an assigning module for assigning each of the coding units to a channel of a plurality of channels reserved in a communication network;
an encoder for encoding each coding unit, based on channel characteristics of the channel to which it has been assigned, to obtain encoded data;
a packetizer for packetizing the encoded data into encoded packets; and
a communication module for transmitting, over each of the reserved channels assigned to, the encoded packets comprising only encoded data of the corresponding assigned coding unit or units.

18. The transmitting device of claim 17, further comprising an aggregating module for aggregating the encoded packets into encoded data frames, wherein aggregating is a channel-oriented aggregating operation that aggregates, into the same data frame, only encoded data of the coding unit or units assigned to the same channel.

19. The transmitting device of claim 17, wherein the assigning module assigns the coding units to channels of said plurality based on characteristics of encoded data resulting from the encoding of corresponding coding units in a previous video frame and on characteristics of said reserved channels.

20. The transmitting device of claim 17, further comprising a coding unit size modifying module for modifying the size of coding units before encoding them, wherein the coding unit size modifying module modifies the size of a coding unit in the current video frame based on an encoded quality value of the encoded data resulting from the encoding of a corresponding coding unit in a previous video frame.

21. The transmitting device of claim 17, further comprising:
a statistics-gathering module for obtaining encoding statistics from the encoded data of first coding units;
a class building module for creating a plurality of classes as a function of at least one item of characteristic information of the obtained statistics; and
a channel reservation module for reserving a plurality of transmission channels for the respective plurality of classes, each channel having a reserved bandwidth that depends on a value of the characteristic information for the respective class,
wherein the assigning module assigns second coding units each to one of the classes;
the communication module transmits the encoded data of each second coding unit over the reserved channel corresponding to the class to which the second coding unit is assigned; and
the encoding of the second coding units depends on the reserved bandwidths of their respective transmission channels.

22. A non-transitory computer-readable medium storing a program which, when executed by a microprocessor or computer system in an apparatus transmitting video frame data over a communication network, causes the apparatus to perform the steps of:
obtain a group of coding units of a current video frame;
assign each of the coding units to a channel of a plurality of channels reserved in a communication network;
encode each coding unit, based on channel characteristics of the channel to which it has been assigned, to obtain encoded data;
packetize the encoded data into encoded packets; and
transmit, over each of the reserved channels assigned to, the encoded packets comprising only encoded data of the corresponding assigned coding unit or units.
